(19) United States
(12) Patent Application Publication
(10) Pub. No.: US 2017/0362776 A1
(43) Pub. Date: Dec. 21, 2017

(54) PRODUCTION OF PAPER AND BOARD

(71) Applicant: BASF SE, Ludwigshafen (DE)

(72) Inventors: Hans-Joachim HAEHNLE, Neustadt (DE); Christoph HAMERS, Schifferstadt (DE); Anton ESSER, Limburgerhof (DE); Hubert MEIXNER, Ludwigshafen (DE); Matthew BUCHAN, Limburgerhof (DE); Norbert SCHALL, Roemerberg (DE); Stefan SPANGE, Orlamuende (DE); Katja TROMMLER, Chemnitz (DE); Hendryk WUERFEL, Chemnitz (DE); Susan SEIFERT, Chemnitz (DE); Tina WALTHER, Chemnitz (DE)

(73) Assignee: BASF SE, Ludwigshafen (DE)

(21) Appl. No.: 15/536,552

(22) PCT Filed: Dec. 4, 2015
(86) PCT No.: PCT/EP2015/078645

§ 371 Date: Jun. 15, 2017

(30) Foreign Application Priority Data
Dec. 16, 2014 (EP) 14198341.1

(51) Int. Cl. D21H 17/42; D21H 17/63; D21H 17/37; B01F 3/12; D21H 15/10; B01F 3/22; D21H 25/04; D21H 17/35; D21H 11/08; D21H 11/04

(52) U.S. Cl. CPC D21H 17/42; D21H 25/04; D21H 17/63; D21H 17/375; D21H 17/35; B01F 3/1214; D21H 15/10; B01F 3/223; B01F 2215/0078; D21H 11/04; D21H 11/08

(57) ABSTRACT

A process for producing paper or board, which process comprises ad-mixing
(I) an aqueous composition of pH ≦6 and
(II) at least one water-soluble polymeric anionic compound
to a paper stock having a pH in the range from 6 to 8 and then dewatering the paper stock by sheet formation and drying,
wherein the aqueous composition comprises
(a) polymers having primary amino groups and/or amidine groups to a combined content for these groups of ≧1.5 meq/g of polymer, and
(b) 0.01 to 50 mol % of 1,4-cyclohexanedione (b) based on the combined amount of primary amino groups and/or amidine groups of the polymers,
and also to the paper or board thus obtained.

The invention relates to a process for producing paper and board of high dry strength by admixing at least an aqueous composition and a polymeric anionic compound to a paper stock, dewatering the paper stock by sheet formation and drying the paper-based products.

Current papermaking processes are directed to conservation of resources by making better use thereof. Particular developments underway within this overall objective are to employ shorter fiber, to reduce the basis weight and to use a higher proportion of filler. These innovations in turn all have an adverse effect on the strength, particularly the dry strength, of paper, so the search is on for novel strength enhancers in this direction in particular. It is particularly in the packaging paper sector that paper strength is an important requirement, since it is significantly reliant on recycled fiber, which loses length in the recycling process, causing a gradual reduction in paper strength.

Processes for producing paper of high dry strength by admixing a water-soluble cationic polymer and also different water-soluble anionic polymers to the paper stock are known, for example from DE 35 06 832, WO 2006/075115 and DE-A 10 2004 056 551.

WO 2004/061235 discloses a process for producing paper, in particular tissue, having particularly high wet and/or dry strengths wherein the paper stock is initially admixed with a water-soluble cationic polymer comprising at least 1.5 meq/g of polymer having primary amino functionalities and a molecular weight of at least 10 000 daltons. Partially and fully hydrolyzed homopolymers of N-vinylformamide are of particular interest here. This is followed by the admixture of a water-soluble anionic polymer comprising anionic and/or aldehydic groups.

Prior European application 14188666.3 relates to an aqueous composition comprising polymers having primary amino groups and/or amidine groups and from 0.01 to 50 mol % of 1,4-cyclohexanedione based on the primary amino groups and amidine groups of the polymers, and also to the employment of said aqueous composition in the manufacture of paper and board of enhanced strength.

The object of the present invention is a process for producing paper and board of reduced basis weight for the same properties, in particular the same strength, or of enhanced strength for the same basis weight.

The present invention accordingly provides a process for producing paper or board, which process comprises admixing
(I) an aqueous composition of pH ≦6 and
(II) at least one water-soluble polymeric anionic compound
to a paper stock having a pH in the range from 6 to 8 and then dewatering the paper stock by sheet formation and drying,
wherein the aqueous composition comprises
(a) polymers having primary amino groups and/or amidine groups to a combined content for these groups of ≧1.5 meq/g of polymer, and
(b) 0.01 to 50 mol % of 1,4-cyclohexanedione (b) based on the combined amount of primary amino groups and amidine groups of the polymers.

The present invention further provides the paper or board thus obtained.

The present inventors found that the separate addition of aqueous composition and water-soluble polymeric anionic compound in the manner of the present invention to the papermaking process leads to paper strength enhancement. One possible explanation for the strength enhancement of the fibers is that the composition leads to a crosslinking reaction of the primary amino groups and any amidine groups of the polymers with the 1,4-cyclohexanedione. A crosslinking reaction of this type would be a pH-dependent equilibrium which, on admixture to the paper stock, which generally has a pH in the range from 7 to 8, is shifted in the direction of the crosslinked structure. As the paper dries, the equilibrium would then become entirely shifted to the right-hand side. The equilibrium of the aqueous composition under acid conditions is entirely on the side of the starting materials, and so the composition is particularly stable under acid conditions.

By combined content of primary amino groups and amidine groups is meant the sum total of the molar fractions of these groups in milliequivalents per gram of polymer (solids).

Any reference in the context of this application to a “polymer having primary amino groups and/or amidine groups (solids)” is to be understood as meaning the amount of polymer without counter-ions. This definition includes potentially charge-bearing structural units in the charged form, i.e., for instance amino groups in the protonated form and acid groups in the deprotonated form. Counter-ions of charged structural units such as Na, chloride, phosphate, formate, acetate, etc. are not included. The determination of the underlying molecular weight of the polymer without counter-ion is described hereinbelow in the context of the examples.

Preference is given to an aqueous composition comprising polymers having primary amino groups and/or amidine groups to a combined content for these groups of ≧1.5 meq/g of polymer and 0.01 to 50 mol % of 1,4-cyclohexanedione (b) based on the combined amount of primary amino groups and amidine groups of the polymers (solids) and ≧50 wt % of water based on the aqueous composition. Particular preference is given to an aqueous composition comprising 60 to 98 wt %, in particular 70 to 95 wt % of water based on the aqueous composition.

The pH of the composition is ≦6 according to the present invention. The composition thus has an acidic pH. The composition preferably has a pH in the range from 2 to 6.

The pH is determined with a pH electrode on a sample of the aqueous composition at 25° C. and standard pressure.

Polymer Having Primary Amino Groups and/or Amidine Groups

The polymers with primary amino groups and/or amidine groups are polymers with primary amino groups and optionally amidine groups. They typically have average molecular weights M_{w} (determined via static light scattering) in the range from 10 000 to 10 000 000 daltons, preferably in the range from 20 000 to 5 000 000 daltons, more preferably in the range from 40 000 to 3 000 000 daltons. Very particular preference is given to a 2 000 000 dalton upper limit for the average molecular weight.

The average molecular weight M_{w} is, here and below, the mass-average molecular weight.

Polymers having primary amino groups and/or amidine groups are cationizable by adduction of protons and therefore have a cationic charge in aqueous solution at pH 7.

Polymers having primary amino groups and/or amidine groups may also be amphoteric provided they have a net cationic charge. The cationic group content of the polymers should be at least 5 mol %, preferably at least 10 mol % above the anionic group content.

Polymers with primary amino groups and/or amidine groups are known, cf. the cited prior art documents DE 35 06 832 A1 and DE 10 2004 056 551 A1.

Copolymers are referred to hereinbelow as well as homopolymers, i.e., polymers formed from one monomer. This term “copolymers” comprehends not only polymers formed from two monomers but also polymers formed from more than two monomers, for example terpolymers.

Any reference hereinbelow to a copolymer which “is obtainable by polymerization of” followed by an enumeration of monomers is to be understood as meaning that the monomer composition comprises these monomers as principal constituent. Preferably, the monomer composition consists of these monomers to an extent of at least 95 wt %, in particular to an extent of 100 wt %.

The polymers having primary amino groups and/or amidine groups are preferably selected from the group of polymer classes consisting of:
(A) hydrolyzed homopolymers of N-vinylcarboxamide
(B) hydrolyzed copolymers of N-vinylcarboxamide and further neutral monoethylenically unsaturated monomers
(C) hydrolyzed copolymers of N-vinylcarboxamide with anionic monoethylenically unsaturated monomers having a level of cationic groups which are at least 5 mol % above the level of anionic groups
(D) hydrolyzed copolymers of N-vinylcarboxamide with cationic monoethylenically unsaturated monomers
(E) hydrolyzed homopolymers of N-vinylcarboxamide which have been converted in a polymer-analogous manner
(F) Hofmann degradation products of homo- or copolymers of (meth)acrylamide
(G) polymers comprising ethyleneimine units

The polymers having primary amino groups and/or amidine groups are more preferably selected from the group of polymer classes consisting of:
(A) hydrolyzed homopolymers of N-vinylcarboxamide
(B) hydrolyzed copolymers of N-vinylcarboxamide and further neutral monoethylenically unsaturated monomers
(D) hydrolyzed copolymers of N-vinylcarboxamide with cationic monoethylenically unsaturated monomers
(E) hydrolyzed homopolymers of N-vinylcarboxamide which have been converted in a polymer-analogous manner

(A) Partially and fully hydrolyzed homopolymers of N-vinylcarboxamide are obtainable by polymerizing at least one N-vinylcarboxamide of the formula

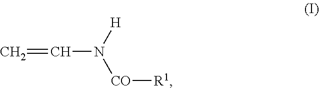

where R¹ is H or C₁-C₆ alkyl, preferably R¹ is H, and optionally compounds (iii), which have at least two ethylenically unsaturated double bonds in the molecule,
and subsequent partial or complete hydrolysis of the polymerized units of monomers (I) in the polymer to form amino groups.

Hydrolyzing the carboxamide moieties of the polymerized units of monomers (I) converts the —NH—CO—R¹ group into the —NH₂ group. Hydrolyzed homopolymers of N-vinylcarboxamide are customarily referred to as polyvinylamines, which are characterized by their degree of hydrolysis.

Preference is given to partially and fully hydrolyzed homopolymers having a ≧10 mol %, preferably ≧20 mol % and especially ≧30 mol % degree of hydrolysis. Their degree of hydrolysis of the polyvinylamines is synonymous with the polymers' combined content of primary amino groups and amidine groups when it is expressed, on a molar basis, as a percentage of the N-vinylcarboxamide units originally present.

The degree of hydrolysis is quantifiable by analyzing the formic acid released in the course of hydrolysis. The latter is accomplished enzymatically for example, using a test kit from Boehringer Mannheim. The combined content of primary amino groups and amidine groups of partially/fully hydrolyzed vinylformamide homopolymers is computed in a conventional manner from the analytically quantified degree of hydrolysis and the amidine/primary amino group ratio quantified using ¹³C NMR spectroscopy.

In case of copolymers or polymer-analogously converted polymers, the molar composition of the polymer's structural units as present at the end of the reaction is determined from the usage quantities of monomers, the quantified degree of hydrolysis, the ratio of amidine to primary amino groups and, if applicable, the polymer-analogously converted proportion. Knowing the molar mass of the individual structural units, said molar composition can be used to compute, in meq, the molar proportion of primary amino groups and/or amidine units which is present in 1 g of polymer.

Amidine groups, as will be common general knowledge, can form in partially hydrolyzed homo- and copolymers of vinylformamide. Adjacent amino and formamide groups may combine in ring closure and hence amidine formation. The result is a six-membered ring of amidine structure:

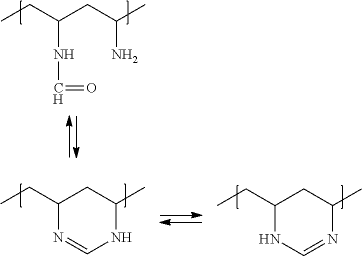

Since the amidine unit is in dynamic equilibrium with adjacent vinylamine and vinylformamide units and is likewise reactive with 1,4-cyclohexanedione, it also contributes to efficacy in the composition of the present invention. Quantification of the degree of hydrolysis captures equally formation of amidine units as well as the formation of primary amino groups, since exactly one molecule of formic acid is released in both cases.

(B) Hydrolyzed copolymers of N-vinylcarboxamide with further neutral monoethylenically unsaturated monomers are obtainable by polymerization of
(i) at least one monomer of the formula

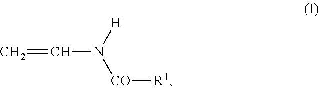

where R¹ is H or C₁-C₆ alkyl,
(iia) at least one further neutral monoethylenically unsaturated monomer, and
(iii) optionally compounds having at least two ethylenically unsaturated double bonds in the molecule,
   and subsequent partial or complete hydrolysis of the polymerized units of monomers (I) in the polymer to form amino groups.

Polymers (B) are preferably reaction products obtainable by copolymerization of
(i) N-vinylformamide and
(ii) acrylonitrile and/or vinyl acetate
   and subsequent elimination of formyl groups from the polymerized vinylformamide units in the copolymer to leave amino groups.

Where copolymers with vinyl acetate are concerned, the conditions of hydrolysis will generally also hydrolyze the ester group to the alcohol, with the formation of vinyl alcohol units. This also holds for the hereinbelow described copolymers (C) and (D).

(C) Hydrolyzed copolymers of N-vinylcarboxamide with anionic monoethylenically unsaturated monomers are obtainable by polymerizing
(i) at least one monomer of the formula

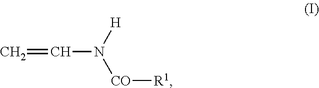

where R¹ is H or C₁-C₆ alkyl,
(iib) one or more monomers selected from monoethylenically unsaturated sulfonic acids, monoethylenically unsaturated phosphonic acids, monounsaturated esters of phosphoric acid, monoethylenically unsaturated carboxylic acids having 3 to 8 carbon atoms in the molecule and/or their alkali metal, alkaline earth metal or ammonium salts, and
(ii,a) optionally one or more further neutral monoethylenically unsaturated monomers,
(iii) optionally compounds having at least two ethylenically unsaturated double bonds in the molecule
   and then partially or completely hydrolyzing the polymerized units of monomers (I) in the polymer to form amino groups, wherein the level of amino groups in the copolymer exceeds by at least 5 mol % the level of polymerized acid groups of monomers (ii,b).

Preference is given to amphoteric polymers having primary amino groups and/or amidine groups (C) obtainable by copolymerization of
(i) N-vinylformamide,
(ii,b) acrylic acid, methacrylic acid and/or their alkali metal, alkaline earth metal or ammonium salts and optionally
(ii,a) acrylonitrile and/or methacrylonitrile
   and subsequent partial or complete cleavage of formyl groups from the N-vinylformamide polymerized in the polymer to leave amino groups, wherein the level of amino groups in the copolymer exceeds by at least 5 mol % the level of polymerized acid groups of monomers (ii,b).

(D) Hydrolyzed copolymers of N-vinylcarboxamide with cationic monoethylenically unsaturated monomers are obtainable by polymerization of
(i) at least one monomer of the formula

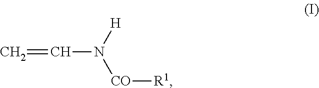

where R¹ is H or C₁-C₆ alkyl,
(iic) optionally one or more monomers selected from monoethylenically unsaturated monomers bearing protonatable secondary or tertiary amino groups and quaternized monoethylenically unsaturated monomers
(iia) optionally one or more further neutral monoethylenically unsaturated monomers
(iii) optionally compounds having at least two ethylenically unsaturated double bonds in the molecule
   and subsequent partial or complete hydrolysis of the polymerized units of monomers I in the polymer to form amino groups.

Preference is given to amphoteric polymers having primary amino groups and/or amidine groups (C) obtainable by copolymerization of
(i) N-vinylformamide,
(ii,c) diallyldimethylammonium chloride and optionally
(ii,a) acrylonitrile and/or methacrylonitrile
   and subsequent partial or complete hydrolysis of the polymerized units of monomers I in the polymer to form amino groups.

Examples of formula I monomers include N-vinylformamide, N-vinylacetamide, N-vinylpropionamide and N-vinylbutyramide. The monomers of group (i) are usable alone or in a mixture in the copolymerization with the monomers of the other groups. N-Vinylformamide is a preferably employed monomer of this group.

Copolymerizing N-vinylcarboxamides (i) together with (ii) at least one other monoethylenically unsaturated monomer and then hydrolyzing the copolymers to form amino groups is a way to arrive at copolymers (B), (C) and (D).

By “further monomers (iia)” are meant monomers other than the monomers of formula I. They are further neutral (uncharged), i.e., bearing neither cationic nor anionic moieties, and hence differ from the monomers of groups (iib) and (iic).

Examples of neutral monomers of group (iia) include monoesters of α,β-ethylenically unsaturated mono- and dicarboxylic acids with C₁-C₃₀ alkanols, C₂-C₃₀ alkanediols, amides of α,β-ethylenically unsaturated monocarboxylic acids and their N-alkyl and N,N-dialkyl derivatives, nitriles of α,β-ethylenically unsaturated mono- and dicarboxylic acids, esters of vinyl alcohol and allyl alcohol with C₁-C₃₀ monocarboxylic acids, N-vinyllactams, nonnitrogenous heterocycles with α,β-ethylenically unsaturated double bonds, vinylaromatics, vinyl halides, vinylidene halides, C₂-C₈ monoolefins and mixtures thereof.

Suitable representatives include, for example, methyl (meth)acrylate (this notation here and hereinbelow symbolizes both “acrylates” and “methacrylates”), methyl ethacrylate, ethyl (meth)acrylate, ethyl ethacrylate, n-butyl (meth)acrylate, isobutyl (meth)acrylate, tert-butyl (meth)acrylate, tert-butyl ethacrylate, n-octyl (meth)acrylate, 1,1,3,3-tetramethylbutyl (meth)acrylate, ethylhexyl (meth)acrylate and mixtures thereof.

Useful monomers of group (iia) further include 2-hydroxyethyl (meth)acrylate, 2-hydroxyethyl ethacrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate and mixtures thereof.

Suitable additional monomers of the group (iia) further include acrylamide, methacrylamide, N-methyl(meth)acrylamide, N,N-dimethyl(meth)acrylamide, N-isopropyl(meth)acrylamide, N-ethyl(meth)acrylamide, n-propyl(meth)acrylamide, N-(n-butyl)(meth)acrylamide, tert-butyl(meth)acrylamide, n-octyl(meth)acrylamide, 1,1,3,3-tetramethylbutyl(meth)acrylamide, ethylhexyl(meth)acrylamide and mixtures thereof.

Examples of monomers of group (iia) further include nitriles of α,β-ethylenically unsaturated mono- and dicarboxylic acids such as for example acrylonitrile and methacrylonitrile. The presence of units of these monomers in the copolymer during and/or after the hydrolysis leads to products which may include an additional type of amidine unit, cf. for instance EP-A 0 528 409 or DE-A 43 28 975. This is because the hydrolysis of these copolymers gives rise, in a secondary reaction, to 5-ring amidine units as a result of vinylamine units reacting with an adjacent nitrile group in the polymer.

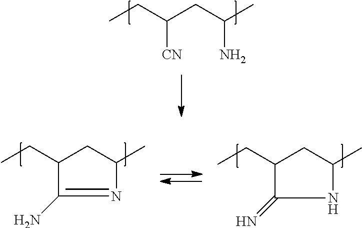

These 5 ring amidines also contribute to the reactivity with the 1,4-cyclohexanedione. Since the formation of a 5-ring amidine likewise gives rise to precisely one molecule of formic acid, these are also co-captured in the quantification of the degree of hydrolysis and hence in the computation of the combined fraction of primary amino groups and amidine groups.

Suitable monomers of group (iia) further include N-vinyllactams and their derivatives, which may for example have one or more C₁-C₆ alkyl substituents (as defined above). These include N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam and mixtures thereof.

Suitable monomers of group (iia) further include ethylene, propylene, isobutylene, butadiene, styrene, α-methylstyrene, vinyl formate, vinyl acetate, vinyl propionate, vinyl chloride, vinylidene chloride, vinyl fluoride, vinylidene fluoride and mixtures thereof.

Acrylonitrile and vinyl acetate are particularly preferred for use as monomers of group (iia).

The aforementioned monomers (iia) are usable singly or as any desired mixtures. They are typically used in amounts of 1 to 90 mol %, preferably 10 to 80 mol % and more preferably 10 to 60 mol % based on the overall monomer composition.

Polymers having primary amino groups and/or amidine groups are also obtainable by using monoethylenically unsaturated monomers of group (ii) which are anionic monomers, referred to above as monomers (iib). They may optionally be copolymerized with the above-described neutral monomers (iia) and/or cationic monomers (iic).

Anionic monomers are formed from monomers comprising acidic groups by elimination of protons. Examples of anionic monomers of group (iib) include ethylenically unsaturated C₃-C₈ carboxylic acids such as, for example, acrylic acid, methacrylic acid, dimethacrylic acid, ethacrylic acid, maleic acid, fumaric acid, itaconic acid, mesaconic acid, citraconic acid, methylenemalonic acid, allylacetic acid, vinylacetic acid and crotonic acid. Useful monomers of this group further include sulfo-containing monomers such as vinylsulfonic acid, acrylamido-2-methylpropanesulfonic acid, allyl- and methallylsulfonic acid and styrenesulfonic acid, phosphono-containing monomers such as vinylphosphonic acid and also monoalkyl phosphate groups. The monomers of this group are usable in the copolymerization alone or mixed with each other, in partially or in completely neutralized form. Useful neutralizing agents include, for example, alkali metal or alkaline earth metal bases, ammonia, amines and/or alkanolamines. Examples thereof are aqueous sodium hydroxide solution, aqueous potassium hydroxide solution, sodium carbonate, potassium carbonate, sodium bicarbonate, magnesium oxide, calcium hydroxide, calcium oxide, triethanolamine, ethanolamine, morpholine, diethylenetriamine or tetraethylenepentamine.

Particular preference for use as monomers of group (iib) is given to acrylic acid, methacrylic acid, vinylsulfonic acid, vinylphosphonic acid and acrylamido-2-methylpropanesulfonic acid.

Cationic monomers comprise basic groups and are either cationic through quaternization or cationizable through adduction of protons.

Suitable cationic monomers (iic), which are copolymerizable, include the esters of α,β-ethylenically unsaturated mono- and dicarboxylic acids with aminoalcohols, preferably C₂-C₁₂ aminoalcohols. These may be C₁-C₈ monoalkylated or dialkylated at the amine nitrogen. Useful acid components for these esters include, for example, acrylic acid, methacrylic acid, fumaric acid, maleic acid, itaconic acid, crotonic acid, maleic anhydride, monobutyl maleate and mixtures thereof. It is preferable to use acrylic acid, methacrylic acid and mixtures thereof.

Preferred monomers are dialkylaminoethyl(meth)acrylamides, dialkylaminopropyl(meth)acrylamides, diallyldimethylammonium chloride, vinylimidazole, alkylvinylimidazoles and also the cationic monomers each neutralized and/or quaternized with mineral acids.

Individual examples of the esters of α,β-ethylenically unsaturated mono- and dicarboxylic acids with aminoalcohols include N-methylaminomethyl (meth)acrylate, N-methylaminoethyl (meth)acrylate, N,N-dimethylaminomethyl (meth)acrylate, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminocyclohexyl (meth)acrylate.

Useful dialkylated amides of α,β-ethylenically unsaturated mono- and dicarboxylic acids with diamines include, for example, dialkylaminoethyl(meth)acrylamides, dialkylaminopropyl(meth)-acrylamides, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[2-(diethylamino)ethyl]methacrylamide.

Examples of methylvinylimidazoles include 1-vinyl-2-methylimidazole, 3-vinylimidazole N-oxide, 2- and 4-vinylpyridine N-oxides and also betaine derivatives of these monomers.

Diallyldimethylammonium chloride (DADMAC) is particularly preferred for use as monomer of group (iic).

Neutralization/quaternization of cationic monomers may be complete or else only partial, for example in the range from 1 to 99% in each case. Methyl chloride is a preferably employed quaternizing agent for cationic monomers. However, the monomers may also be quaternized with dimethyl sulfate, diethyl sulfate or with other alkyl halides such as ethyl chloride or benzyl chloride.

Further modification of the copolymers is possible by copolymerizing with monomers of group (iii), which comprise at least two double bonds in the molecule, e.g., triallylamine, methylenebisacrylamide, glycol diacrylate, glycol dimethacrylate, glycerol triacrylate, pentaerythritol triallyl ether, N,N-divinylethyleneurea, tetraallylammonium chloride, at least di-acrylated and/or -methacrylated polyalkylene glycols or polyols such as pentaerythritol, sorbitol and glucose. Monomers of group (iii) act as crosslinkers. DADMAC monomer is therefore regarded as belonging not to this group, but to the cationic monomers. When at least one monomer of the above group is used in the polymerization, the amounts employed range up to 2 mol %, for example from 0.001 to 1 mol %.

To modify the polymers it may further be sensible to combine the employment of the above crosslinkers with the addition of chain transfer agents. Typically from 0.001 to 5 mol % is used, based on the overall monomer composition. Any chain transfer agents known to the literature are useful, e.g., sulfur compounds such as mercaptoethanol, 2-ethylhexyl thioglycolate, thioglycolic acid and dodecyl mercaptan and also sodium hypophosphite, formic acid or tribromochloromethane.

The above-described polymers having primary amino groups and/or amidine groups of classes (A), (B), (C) and (D) are obtainable by solution, precipitation, suspension or emulsion polymerization. Solution polymerization in aqueous media is preferable. Suitable aqueous media are water and mixtures of water and at least one water-miscible solvent, for example an alcohol, such as methanol, ethanol, n-propanol or isopropanol.

The copolymers are hydrolyzable in the presence of acids or bases or else enzymatically. When acids are used for the hydrolysis, the amino groups formed from the vinylcarboxamide units are in salt form. The hydrolysis of vinylcarboxamide copolymers is described in EP-A 0 438 744, page 8 line 20 to page 10 line 3 at length. The observations made there apply mutatis mutandis to the preparation of the polymers, having primary amino groups and/or amidine groups, to be used according to the invention. The polymers having primary amino groups and/or amidine groups are also employable in the method of the present invention in the form of free bases. Polymers of this type are generated, for example, when polymers comprising vinylcarboxylic acid units are hydrolyzed with bases.

Preference is given to partially and fully hydrolyzed copolymers of classes (B), (C) and (D) with a ≧10 mol %, preferably ≧20 mol % and especially ≧30 mol % degree of hydrolysis.

Preference is given to partially and fully hydrolyzed copolymers of classes (B), (C) and (D) obtainable by polymerization of
30-99 mol % of at least one monomer of the formula

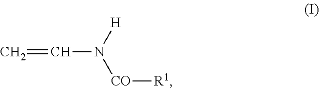

where R¹ is H or C₁-C₆ alkyl,
0-70 mol % of one or more further neutral monoethylenically unsaturated monomers (iia),
0-70 mol % of one or more monomers (iib) selected from monoethylenically unsaturated sulfonic acids, monoethylenically unsaturated phosphonic acids, monounsaturated esters of phosphoric acid, monoethylenically unsaturated carboxylic acids having 3 to 8 carbon atoms in the molecule and/or their alkali metal, alkaline earth metal or ammonium salts,
0-70 mol % of one or more monomers (iic) selected from monoethylenically unsaturated monomers bearing protonatable secondary or tertiary amino groups and quaternized monoethylenically unsaturated monomers,
   all based on the overall monomer composition and
   optionally compounds having at least two ethylenically unsaturated double bonds in the molecule,
   with the proviso that the sum total for the fractions of monomers (iia), (iib) and (iic) is altogether in the range from 1 to 70 mol %, and subsequent partial or complete hydrolysis of the polymerized units of monomers (I) in the polymer to form amino groups, wherein the level of amino groups in the copolymer exceeds by at least 5 mol % the level of polymerized acid groups of monomers (ii,b). Copolymers of this type which have a degree of hydrolysis ≧30 mol % are particularly preferred.

Particular preference is given to partially and fully hydrolyzed copolymers of N-vinylcarboxamide with further neutral, anionic and/or cationic monoethylenically unsaturated monomers, wherein this monomer is selected from acrylonitrile, vinyl acetate, sodium acrylate, DADMAC, [3-(dimethylamino)propyl]acrylamide, N-[3-(dimethylamino)propyl]methacrylamide and the quaternized compounds of [3-(dimethylamino)propyl]acrylamide and N-[3-(dimethylamino)propyl]methacrylamide which are obtainable by reacting the last two compounds, respectively, with methyl chloride. Those where the degree of hydrolysis is ≧30 mol % are particularly preferred. Very particular preference is given to partially or fully hydrolyzed copolymers of N-vinylcarboxamide with sodium acrylate, and a degree of hydrolysis ≧30 mol %.

E) Hydrolyzed homopolymers of N-vinylcarboxamide which have been converted in a polymer-analogous manner

The polymer-analogously converted polymers of class A), i.e., polymer-analogously converted polyvinylamines, are also suitable, provided these reaction products have the combined content with regard to primary amino groups and/or amidine groups which is essential to the present invention. Suitable polymer-analogous conversions are the conversions with Michael systems as described in WO2007/136756. Michael systems are compounds having an unsaturated double bond conjugated to an electron-withdrawing group. Suitable Michael systems fall within general formula II

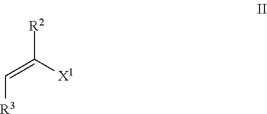

where R² and R³ are each independently H, alkyl, alkenyl, carbonyl, carboxyl or carboxamide and X¹ is an electron-withdrawing group or an amino group.

Examples of Michael systems include acrylamide, N-alkylacrylamide, methacrylamide, N,N-dimethylacrylamide, N-alkylmethacrylamide, N-(2-methylpropanesulfonic acid)acrylamide, N-(glycolic acid)acrylamide, N-[3-(propyl)trimethylammonium chloride]acrylamide, acrylonitrile, methacrylonitrile, acrolein, methyl acrylate, alkyl acrylate, methyl methacrylate, alkyl methacrylate, aryl acrylate, aryl methacrylates, [2-(methacryloyloxy)ethyl]trimethylammonium chloride, N-[3-(dimethylamino)propyl]methacrylamide, N-ethylacrylamide, 2-hydroxyethyl acrylate, 3-sulfopropyl acrylate, 2-hydroxyethyl methacrylate, glycidyl methacrylates, pentafluorophenyl acrylate, ethylene diacrylate, ethylene dimethacrylate, heptafluorobutyl acrylate, poly(methyl methacrylate), acryloylmorpholine, 3-(acryloyloxy)-2-hydroxypropyl methacrylate, dialkyl maleate, dialkyl itaconate, dialkyl fumarate, 2-cyanoethyl acrylate, carboxyethyl acrylate, phenylthioethyl acrylate, 1-adamantyl methacrylate, dimethylaminoneopentyl acrylate, 2-(4-benzoyl-3-hydroxyphenoxy)ethyl acrylate and dimethylaminoethyl methacrylate.

Acrylamide is the preferred Michael system. The Michael systems are used in an amount of 1 to 75 mol % based on the combined amount of primary amino groups and amidine groups. The reaction conditions for the conversion are described in WO2007/136756, the disclosure of which is expressly incorporated herein by reference.

E) Preference is likewise given to polymer-analogous conversions of the primary amino groups and/or amidine groups of polymers A). The conversion products preferably comprise structural units selected from the group of polymer units (Ill), (IV), (V), (VI) and (VII)

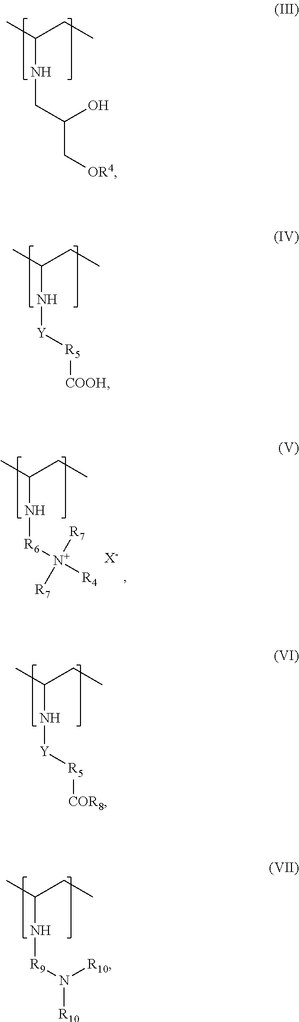

where
X— is an anion, preferably chloride, bromide or iodide;
Y is carbonyl or methylene or a single bond;
R₄ is hydrogen or linear or branched C₁-C₂₂ alkyl;
R₅ is linear or branched C₁-C₁₅ alkylene or linear or branched C₁-C₁₅ alkenylene;
R₆ is linear or branched C₁-C₁₂ alkylene optionally substituted with hydroxyl, preferably CH₂CH(OH)CH₂— or -ethylene;
R₇ is hydrogen or linear or branched C₁-C₂₂ alkyl, preferably methyl or ethyl;
R₈ is hydrogen, linear or branched C₁-C₂₂ alkyl, linear or branched C₁-C₂₂ alkoxy, amino, linear or branched C₁-C₂₂ alkylamino or linear or branched C₁-C₂₂ dialkylamino, preferably amino;
R₉ is linear or branched C₁-C₁₂ alkylene, preferably ethylene;
R₁₀ is hydrogen, linear or branched C₁-C₂₂ alkyl, preferably methyl or ethyl.

The reaction conditions for the conversion are described in WO2009/017781, the disclosure of which is expressly incorporated herein by reference.

Conversion products comprising units of formula III are obtainable by polymer-analogous conversion of primary amino groups and/or amidine groups of polyvinylamines (polymers A) with alkylating agents. Alkylation may further be effected with alkyl glycidyl ethers, glycidol (2,3-epoxy-1-propanol) or chloropropanediol. Preferred alkyl glycidyl ethers are butyl glycidyl ether, 2-ethylhexyl glycidyl ether, hexadecyl glycidyl ether and C₁₂/C₁₄ glycidyl ethers. The conversion with alkyl glycidyl ethers is generally performed in water, but may also be performed in water/organic solvent mixtures.

Conversion products comprising units of formulae IV and VI are obtainable by polymer-analogous conversion of primary amino groups and/or amidine groups of polyvinylamines (polymers A) with alkylating agents or acylating agents.

Only the conversion products of structures IV and VI may—under the substituent definitions overleaf—contain anionic groups.

Where the reaction products concerned comprise anionic groups, the level of cationic groups in the reaction products shall be at least 5 mol % above the level of anionic groups in the reaction products.

Acylating agents of this type are selected from succinic anhydride, substituted succinic anhydrides with linear or branched C₁-C₁₈ alkyl or linear or branched C₁-C₁₈ alkenyl substitution, maleic anhydride, glutaric anhydride, 3-methylglutaric anhydride, 2,2-dimethylsuccinic anhydride, cyclic alkyl carboxylic anhydrides, cyclic alkenyl carboxylic anhydrides, alkenylsuccinic anhydrides (ASAs), chloroacetic acid, salts of chloroacetic acid, bromoacetic acid, salts of bromoacetic acid, halogen-substituted alkanoic acid acrylamides and halogen-substituted alkenoic acid acrylamides.

Alkylating agents of this type are selected from 3-chloro-2-hydroxypropyltrimethylammonium chloride, 2-(diethylamino)ethyl chloride hydrochloride, (dialkylamino)alkyl chlorides such as 2-(dimethylamino)ethyl chloride, 3-chloro-2-hydroxypropylalkyldimethylammonium chlorides such as 3-chloro-2-hydroxypropyllauryldimethylammonium chloride, 3-chloro-2-hydroxypropyl-cocoalkyldimethylammonium chloride, 3-chloro-2-hydroxypropylstearyldimethylammonium chloride, (haloalkyl)trimethylammonium chlorides such as (4-chlorobutyl)trimethylammonium chloride, (6-chlorohexyl)trimethylammonium chloride, (8-chlorooctyl)trimethylammonium chloride and (glycidylpropyl)trimethylammonium chloride.

(F) Hofmann degradation products of homo- or copolymers of (meth)acrylamide Polymers having primary amino groups may also be the reaction products obtainable by Hofmann degradation of homo- or copolymers of acrylamide or of methacrylamide in an aqueous medium in the presence of sodium hydroxide and sodium hypochlorite and subsequent decarboxylation of the carbamate groups of the conversion products in the presence of an acid. Polymers of this type are known, for example from EP-A 0 377 313 and WO 2006/075115. The preparation of polymers comprising vinylamine groups is exhaustively treated, for example, in WO 2006/075115, page 4 line 25 to page 10 line 22 and in the examples on pages 13 and 14. The statements made there apply to the characterization of the polymers comprising vinylamine units and prepared by Hofmann degradation. The polymer content without counter-ion and the amino group content of this type of polymers are quantified in a conventional manner by polyelectrolyte titration and NMR measurements.

The starting polymers comprise acrylamide and/or methacrylamide units. They are homo- and/or copolymers of acrylamide and methacrylamide. Useful comonomers include, for example, dialkylaminoalkyl(meth)acrylamides, diallylamine, methyldiallylamine and also the salts of the amines, and the quaternized amines. Useful comonomers further include dimethyldiallylammonium salts, acrylamidopropyltrimethylammonium chloride and/or methacrylamidopropyltrimethylammonium chloride, N-vinylformamide, N-vinylacetamide, N-vinylpyrrolidone, vinyl acetate and acrylic and methacrylic esters. Useful comonomers optionally also include anionic monomers such as acrylic acid, methacrylic acid, maleic anhydride, maleic acid, itaconic acid, acrylamidomethylpropanesulfonic acid, methallylsulfonic acid and vinylsulfonic acid and also the alkali metal, alkaline earth metal and ammonium salts of the acidic monomers referred to. The amount of water-insoluble monomers in the polymerization is chosen such that the polymers formed are water soluble.

Useful comonomers optionally further include crosslinkers, e.g., ethylenically unsaturated monomers comprising at least two double bonds in the molecule, such as triallylamine, methylenebisacrylamide, ethylene glycol diacrylate, ethylene glycol dimethacrylate, polyethylene glycol dimethacrylate, triallylamine and trimethylol trimethacrylate. When a crosslinker is used, the amounts used are for example in the range from 5 to 5000 ppm. The monomers may be polymerized according to any known method, for example by free-radically initiated solution, precipitation or suspension polymerization. The presence of customary chain transfer agents during the polymerization is optional.

Hofmann degradation proceeds for example from 20 to 40 wt % aqueous solutions of at least one polymer comprising acrylamide and/or methacrylamide units. The ratio of alkali metal hypochlorite to (meth)acrylamide units in the polymer is determinative for the resultant level of amine groups in the polymer. The molar ratio of alkali metal hydroxide to alkali metal hypochlorite is for example in the range from 2 to 6 and preferably in the range from 2 to 5. The amount of alkali metal hydroxide required to degrade the polymer is computed on the basis of a particular amine group level in the degraded polymer.

The Hofmann degradation of the polymer is carried out, for example, in the temperature range from 0 to 45° C., preferably 10 to 20° C., in the presence of quaternary ammonium salts as a stabilizer in order to prevent any secondary reaction of the resultant amino groups with the amide groups of the starting polymer. After the conversion with alkali metal hydroxide solution/alkali metal hypochlorite has ended, the aqueous reaction solution is routed into a reactor containing an initial charge of an acid for decarboxylating the conversion product. The pH of the reaction product comprising vinylamine units is adjusted to a value in the range from 2 to 7. The concentration of the degradation product comprising vinylamine units is, for example, more than 3.5 wt %, usually it is above 4.5 wt %. The aqueous polymer solutions are concentratable by ultrafiltration for example.

(G) polymers comprising ethyleneimine units are further useful as polymers having primary amino groups. They typically contain a mixture of primary, secondary and tertiary amino groups. The level of amino groups, and their distribution as between primary, secondary and tertiary ones, of polymers containing ethyleneimine units is quantified in a conventional manner via NMR.

Polymers comprising ethyleneimine units include any polymers obtainable by polymerization of ethyleneimine in the presence of acids, Lewis acids or haloalkanes, such as homopolymers of ethyleneimine or graft polymers of ethyleneimine, cf. U.S. Pat. No. 2,182,306 or in U.S. Pat. No. 3,203,910. These polymers may optionally be subjected to subsequent crosslinking. Useful crosslinkers include, for example, any multifunctional compounds comprising groups reactive with primary amino groups, e.g., multifunctional epoxides such as bisglycidyl ethers of oligo- or polyethylene oxides or other multifunctional alcohols such as glycerol or sugars, multifunctional carboxylic esters, multifunctional isocyanates, multifunctional acrylic or methacrylic esters, multifunctional acrylic or methacrylic amides, epichlorohydrin, multifunctional acyl halides, multifunctional nitriles, α,ω-chlorohydrin ethers of oligo- or polyethylene oxides or of other multifunctional alcohols such as glycerol or sugars, divinyl sulfone, maleic anhydride or ω-halocarbonyl chlorides, multifunctional haloalkanes specifically α,ω-dichloroalkanes. Further crosslinkers are described in WO 97/25367 pages 8 to 16.

Polymers comprising ethyleneimine units are known, for example from EP-A-0411400, DE 2434816 and U.S. Pat. No. 4,066,494. The primary amino content of the described polymers comprising ethyleneimine is typically in the range from 10 to 40 mol %.

By way of (b) polymers comprising ethyleneimine units, the method of the present invention utilizes, for example, at least one water-soluble cationic polymer from the group consisting of
homopolymers of ethyleneimine,
polyethyleneimines converted with at least bifunctional crosslinkers,
ethyleneimine-grafted polyamidoamines converted with at least bifunctional crosslinkers,
conversion products of polyethyleneimines with monobasic carboxylic acids to form amidated polyethyleneimines,
Michael addition products of polyethyleneimines onto ethylenically unsaturated acids, salts, esters, amides or nitriles of monoethylenically unsaturated carboxylic acids,
phosphonomethylated polyethyleneimines,
carboxylated polyethyleneimines, and
alkoxylated polyethyleneimines.

Polymers obtained by first condensing at least one polycarboxylic acid with at least one polyamine to form polyamidoamines, then grafting with ethyleneimine and subsequently crosslinking the conversion products with one of the abovementioned compounds are among the preferred compounds comprising ethyleneimine units. A method of preparing such compounds is for example described in DE-A-2434816, while α,ω-chlorohydrin ethers of oligo- or polyethylene oxides are used as crosslinkers.

Ultrafiltrated products of this type are exhaustively described in WO 00/67884 and WO 97/25367.

Conversion products of polyethyleneimines with monobasic carboxylic acids into amidated polyethyleneimines are known from WO 94/12560. Michael addition products of polyethyleneimines onto ethylenically unsaturated acids, salts, esters, amides or nitriles of monoethylenically unsaturated carboxylic acids form part of the subject matter of WO 94/14873. Phosphonomethylated polyethyleneimines are exhaustively described in WO 97/25367. Carboxylated polyethyleneimines are obtainable for example in a Strecker synthesis by conversion of polyethyleneimines with formaldehyde and ammonia/hydrogen cyanide and hydrolysis of the conversion products. Alkoxylated polyethyleneimines are obtainable by reacting polyethyleneimines with alkylene oxides such as ethylene oxide and/or propylene oxide.

The molar masses of polymers comprising ethyleneimine units are for example in the range from 10 000 to 3 000 000. The cationic charge of the polymers comprising ethyleneimine units is at least 4 meq/g for example. The cationic charge is usually in the range from 8 to 20 meq/g.

Polymers having primary amino groups and/or amidine units also include hydrolyzed graft polymers of, for example, N-vinylformamide on polyalkylene glycols, polyvinyl acetate, polyvinyl alcohol, polyvinylformamides, polysaccharides such as starch, oligosaccharides or monosaccharides. The graft polymers are obtainable by free-radically polymerizing N-vinylformamide, for example, in an aqueous medium in the presence of at least one of the recited grafting bases optionally together with copolymerizable other monomers and then hydrolyzing the grafted vinylformamide units in a known manner. Graft polymers of this type are described in DE-A-19515943, DE-A-4127733, DE-A-10041211 for example.

Useful polymers with primary amino groups further include polymethyleneamines as described in DE 10233930 and 10305807.

It is likewise possible to use polycondensates bearing primary amino groups, such as polylysine, polyallylamines or polysaccharides with primary amino groups such as chitosan as polymers having primary amino groups.

The aqueous composition of the present invention is prepared by combining the individual components. In general, the aqueous solution of the polymer having primary amino groups and/or amidine groups is introduced as the initial charge and is adjusted to ≦pH6, in which crosslinking does not yet occur to any significant degree, and the 1,4-cyclohexanedione is admixed as a solid substance. Alternatively, the 1,4-cyclohexanedione may also be admixed in the form of an aqueous solution. In a possible further embodiment, the ≦pH6 solution of the polymer having primary amino groups and/or amidine groups is admixed to the 1,4-cyclohexanedione. However, it is preferable to admix the 1,4-cyclohexanedione to the solution of the polymer having primary amino groups and/or amidine groups.

The mixture is preferably prepared at room temperature, but may optionally also be prepared at reduced temperatures down to 0° C. Similarly, the mixture may also be prepared at an elevated temperature of up to 100° C. The admixture at room temperature is preferable.

Any commercially available mixing units capable of handling the viscosities of the polymer solutions are usable.

Mixing should proceed at a minimum until there is a homogeneous aqueous composition. When 1,4-cyclohexanedione was used in the form of a solid material, mixing should be continued until the 1,4-cyclohexanedione has completely dissolved. It is advantageous but not strictly necessary to stir for an hour at least. It is similarly possible to mix the aqueous 1,4-cyclohexanedione solution in-line into the solution of the polymer having primary amino groups and/or amidine groups.

The aqueous composition comprises polymers having primary amino groups and/or amidine groups to a combined content for these groups of ≧1.5 meq/g of polymer (milliequivalent/gram of polymer). Preference is given to a combined content of primary amino groups and/or amidine groups which is in the range from 3 to 32 meq/g of polymer and particularly in the range from 5 to 23 meq/g of polymer.

The amount of 1,4-cyclohexanedione used is from 0.01 to 50 mol %, preferably from 0.1 to 30 mol % and particularly from 0.2 to 15 mol % based on the combined amount of primary amino groups and amidine groups of the polymers.

The aqueous composition of the present invention preferably comprises
(a) 5 to 40 wt %, based on the aqueous composition, of polymers having primary amino groups and amidine groups to a combined content for primary amino groups and amidine groups of ≧1.5 meq/g of polymer, and
(b) 0.1 to 30 mol % of 1,4-cyclohexanedione (b) based on the combined amount of primary amino groups and amidine groups of these polymers.

The aqueous composition of the present invention preferably consists to an extent of at least 95 wt %, in particular 100 wt % of
(a) 5 to 40 wt %, based on the aqueous composition, of polymers having primary amino groups and/or amidine groups to a combined content for these groups of ÷1.5 meq/g of polymer,
(b) 0.1 to 30 mol % of 1,4-cyclohexanedione (b) based on the combined amount of primary amino groups and/or amidine groups of these polymers
and water.

### Water-Soluble Polymeric Anionic Compound

Water-soluble polymeric anionic compounds include any polymers bearing acid groups or salts thereof and having an anionic charge density of >0.1 meq/g (at pH 7).

The acid groups concerned may be carboxyl groups, sulfonic acid groups and phosphonic acid groups. Esters of phosphoric acid are also a possibility, in which case at least one acid function of the phosphoric acid is not esterified. Also of in-principle utility are chain growth addition polymers, polycondensates, e.g., polyaspartic acid, polyaddition compounds and also ring-openingly polymerized compounds having a charge density of >0.5 meq/g in each case. Polymers modified with acidic groups by polymer-analogous reactions such as Strecker reaction or by phosphonomethylation are likewise usable. Preference, however, is given to polymers obtainable by polymerization of:
(1) at least one monomer selected from the group consisting of
   (1.1) monoethylenically unsaturated sulfonic acids, phosphonic acids, phosphoric esters and other phosphoric acid derivatives bearing at least one hydroxyphosphorus group, and
   (1.2) monoethylenically unsaturated mono- and dicarboxylic acids, their salts and dicarboxylic anhydrides,
(2) optionally at least one monoethylenically unsaturated monomer other than said components (1.1) and (1.2), and
(3) optionally at least one compound having at least two ethylenically unsaturated double bonds in the molecule,
   with the proviso that the monomer mixture comprises at least one monomer (1) having at least one free acid group and/or acid group in salt form.

As monomers of group (1.1) there may be used compounds which have an organic moiety having a polymerizable, α,β-ethylenically unsaturated double bond and at least one sulfonic or phosphonic acid group per molecule. Salts of the aforementioned compounds are also suitable. The monoesters or monoamides of phosphonic acids are further also suitable. Suitable monomers (1.1) further include mono- and diesters of phosphoric acid with alcohols having a polymerizable, α,β-ethylenically unsaturated double bond and mono- and diamides of phosphoric acid with amines having a polymerizable, α,β-ethylenically unsaturated double bond. One proton of the phosphoric acid group or both the remaining protons of the phosphoric acid group may be neutralized by suitable bases or esterified with alcohols that have no polymerizable double bonds.

Suitable bases for partly or wholly neutralizing the acid groups of the monomers (1.1) include, for example, alkali metal or alkaline earth metal bases, ammonia, amines and/or alkanolamines. Examples thereof are sodium hydroxide, potassium hydroxide, sodium carbonate, potassium carbonate, sodium bicarbonate, potassium bicarbonate, magnesium hydroxide, magnesium oxide, calcium hydroxide, calcium oxide, triethanolamine, ethanolamine, morpholine, diethylenetriamine or tetraethylenepentamine. Suitable alcohols for esterifying phosphoric acid include, for example, C₁-C₆ alkanols, for example methanol, ethanol, n-propanol, isopropanol, n-butanol, sec-butanol, tert-butanol, n-pentanol, n-hexanol and also isomers thereof.

The monomers (1.1) include, for example, vinylsulfonic acid, allylsulfonic acid, methallylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, acrylamidomethylenephosphonic acid, 2-acrylamido-2-methylpropanesulfonic acid, vinylphosphonic acid, CH₂═CH—NH—CH₂—PO₃H, monomethyl vinylphosphonate, dimethyl vinylphosphonate, allylphosphonic acid, monomethyl allylphosphonate, dimethyl allylphosphonate, acrylamidomethylpropylphosphonic acid, (meth)acryloylethylene glycol phosphate and monoallyl phosphate.

The aforementioned monomers (1.1) can be employed singly or in the form of any desired mixtures to prepare the water-soluble polymeric anionic compound.

As monomers of group (1.2) there may be used monoethylenically unsaturated carboxylic acids having 3 to 8 carbon atoms and also the water-soluble salts such as alkali metal, alkaline earth metal or ammonium salts of these carboxylic acids and the monoethylenically unsaturated carboxylic anhydrides. This group of monomers includes, for example, acrylic acid, methacrylic acid, dimethacrylic acid, ethacrylic acid, α-chloroacrylic acid, maleic acid, maleic anhydride, fumaric acid, itaconic acid, mesaconic acid, citraconic acid, glutaconic acid, aconitic acid, methylenemalonic acid, allylacetic acid, vinylacetic acid and crotonic acid. The monomers of group (1.2) can be employed singly or mixed with one another, in partially or in completely neutralized form in the homo- and/or copolymerization. The compounds recited above in relation to components (1.1) are suitable bases for neutralizing.

The water-soluble polymeric anionic compound comprises at least one monomer from the group (1), selected from sub-groups (1.1) and/or (1.2). It will be appreciated that the water-soluble copolymer may also comprise mixtures of monomers from sub-groups (1.1) and (1.2) in polymerized form.

The copolymers may optionally comprise at least one further monomer of group (2) in polymerized form for modification. These monomers are preferably selected from esters of α,β-ethylenically unsaturated mono- and dicarboxylic acids with C₁-C₃₀ alkanols, C₂-C₃₀ alkanediols and C₂-C₃₀ aminoalcohols, amides of α,β-ethylenically unsaturated monocarboxylic acids and their N-alkyl and N,N-dialkyl derivatives, nitriles of α,β-ethylenically unsaturated mono- and dicarboxylic acids, esters of vinyl alcohol and allyl alcohol with C₁-C₃₀ monocarboxylic acids, N-vinyllactams, nonnitrogenous heterocycles having α,β-ethylenically unsaturated double bonds, vinylaromatics, vinyl halides, vinylidene halides, C₂-C₈ monoolefins and mixtures thereof.

Suitable representatives of group (2) include, for example, methyl (meth)acrylate, methyl ethacrylate, ethyl (meth)acrylate, ethyl ethacrylate, n-butyl (meth)acrylate, isobutyl (meth)acrylate, tert-butyl (meth)acrylate, tert-butyl ethacrylate, n-octyl (meth)acrylate, 1,1,3,3-tetramethylbutyl (meth)acrylate, ethylhexyl (meth)acrylate and mixtures thereof.

Useful monomers of group (2) further include 2-hydroxyethyl (meth)acrylate, 2-hydroxyethyl ethacrylate, 2-hydroxypropyl (meth)acrylate, 3-hydroxypropyl (meth)acrylate, 3-hydroxybutyl (meth)acrylate, 4-hydroxybutyl (meth)acrylate, 6-hydroxyhexyl (meth)acrylate and mixtures thereof.

Suitable additional monomers from group (2) further include N-vinylformamide, N-vinylacetamide, N-methyl, N-vinyl acetamide, N-vinylpropionamide and N-vinylbutyramide, acrylamide, methacrylamide, N-methyl(meth)acrylamide, N,N-dimethyl(meth)acrylamide, N-isopropyl(meth)acrylamide, N-ethyl(meth)acrylamide, n-propyl(meth)acrylamide, N-(n-butyl)(meth)acrylamide, tert-butyl(meth)acrylamide, n-octyl(meth)acrylamide, 1,1,3,3-tetramethylbutyl(meth)acrylamide, ethylhexyl(meth)acrylamide and mixtures thereof.

Further examples of monomers of group (2) are nitriles of α,β-ethylenically unsaturated mono- and dicarboxylic acids such as, for example, acrylonitrile and methacrylonitrile.

Suitable monomers of group (2) further include N-vinyllactams and derivatives thereof, which may for example have one or more C₁-C₆ alkyl substituents (as defined above). These include N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam and mixtures thereof.

Suitable additional monomers of group (2) further include ethylene, propylene, isobutylene, butadiene, styrene, α-methylstyrene, vinyl acetate, vinyl propionate, vinyl chloride, vinylidene chloride, vinyl fluoride, vinylidene fluoride and mixtures thereof.

The aforementioned monomers of group (2) may be employed in the copolymerization with at least one anionic monomer singly or in the form of any desired mixtures.

Further modification of the copolymers is possible by copolymerizing with monomers of group (3), which comprise at least two double bonds in the molecule, e.g., methylenebisacrylamide, glycol diacrylate, glycol dimethacrylate, glycerol triacrylate, pentaerythritol triallyl ether, at least diacrylated and/or -methacrylated polyalkylene glycols or polyols such as pentaerythritol, sorbitol or glucose. When at least one monomer of group (3) is used in the copolymerization, the amounts employed range up to 2 mol %, for example from 0.001 to 1 mol %.

It may further be sensible to combine the employment of the above crosslinkers in the polymerization with the addition of chain transfer agents. Typically from 0.001 to 5 mol % of at least one chain transfer agent is used. Any chain transfer agents known to the literature are useful, e.g., mercaptoethanol, 2-ethylhexyl thioglycolate, thioglycolic acid, dodecyl mercaptan, sodium hypophosphite, formic acid and/or tribromochloromethane.

A preferable form of using the water-soluble polymeric anionic compound is as homopolymers of ethylenically unsaturated C₃ to C₅ carboxylic acids, in particular polyacrylic acid and polymethacrylic acid and also hydrolyzed homopolymers of maleic anhydride and of itaconic anhydride. Anionic copolymers contemplated as preferable comprise for example (1) from 10 to 99 wt % of at least one ethylenically unsaturated C₃ to C₅ carboxylic acid and (2) from 90 to 1 wt % of at least one amide, nitrile and/or ester of an ethylenically unsaturated C₃ to C₅ carboxylic acid in polymerized form. The weight percentages due to components (1) and (2) always add up to 100. Particular preference is given to copolymers of acrylic acid and acrylamide, copolymers of acrylic acid and acrylonitrile, copolymers of acrylic acid and N-vinylformamide, copolymers of methacrylic acid and methacrylamide, copolymers of methacrylic acid and N-vinylformamide, copolymers of acrylic acid and methacrylamide, copolymers of acrylic acid and methacrylonitrile, copolymers of methacrylic acid and methacrylonitrile and copolymers of acrylic acid, acrylamide and acrylonitrile. Preference is further given to copolymers of acrylic acid or methacrylic acid with vinyl acetate and also to copolymers of vinyl acetate, acrylamide and acrylic acid.

Preference is further given to a polymeric anionic compound which is a copolymer of acrylic acid with at least one monomer selected from vinylformamide, vinyl acetate, acrylonitrile and acrylamide.

Polymeric anionic compounds are water-soluble. Water-soluble for the purposes of the present invention is said of polymers that are soluble in water at 25° C. and atmospheric pressure in a concentration of 0.1 wt % at least. They are employable in the process of the present invention in the form of the free acids and/or as alkali metal, alkaline earth metal or ammonium salt. Their K value (determined after H. Fikentscher in 5 wt % aqueous sodium chloride solution at 25° C. and pH 7) is in the range from 50 to 250, for example.

Nomenclature for the shaped article consisting of fibrous material varies with said article's mass per unit area, also known in the art as the basis weight. In what follows, paper and board refer respectively to a mass per unit area of 7 g/m² to 225 g/m² and 225 g/m² or more.

Paper stock (also known as furnish) hereinafter refers to a mixture of materials which consists of readied fibrous material from one or more species and of various auxiliary materials, is suspended in water and is at a stage prior to sheet formation. Paper stock, depending on the stage of the papermaking process, thus further comprises the composition of the present invention, optionally filler and optionally paper auxiliaries. Dry paper stock is to be understood as meaning the overall paper stock—fibrous material, cationic composition used according to the invention, anionic polymeric compound, optionally filler and optionally paper auxiliaries—without water (paper stock solids).

Useful fillers include any pigments customarily usable in the paper industry and are based on metal oxides, silicates and/or carbonates especially pigments from the group consisting of calcium carbonate, as which ground calcium carbonate (GCC), chalk, marble or precipitated calcium carbonate (PCC) can be used, talc, kaolin, bentonite, satin white, calcium sulfate, barium sulfate and titanium dioxide. Mixtures of two or more pigments are also usable.

The process for producing paper and board in the manner of the present invention comprises a step of dewatering a filler-containing paper stock. The filler content of the paper/board may be in the range from 5 to 40 wt % based on the paper/board.

A process for producing paper whose filler content is in the range from 20 to 30 wt % is preferred in a preferred embodiment. Papers of this type are, for example, wood-free papers.

A process for producing paper whose filler content is in the range from 5 to 20 wt % is preferred in a further preferred embodiment. Papers of this type are used particularly as packaging papers.

A process for producing paper whose filler content is in the range from 5 to 15 wt % is preferred in a further preferred embodiment. Papers of this type are used particularly for newsprint.

A process for producing paper whose filler content is in the range from 25 to 40 wt % is preferred in a further preferred embodiment, for example SC papers.

Particular preference is given to a process for producing test liners and fluting and also wood-free papers.

The fibrous material used according to the present invention may comprise virgin and/or recovered fibers. Any softwood or hardwood fiber typically used in the paper industry may be used, examples being mechanical pulp, bleached and unbleached chemical pulp as well as fibrous materials from any annual plants. Mechanical pulp includes for example groundwood, thermomechanical pulp (TMP), chemithermomechanical pulp (CTMP), pressure groundwood, semichemical pulp, high-yield pulp and refiner mechanical pulp (RMP). Sulfate, sulfite and soda chemical pulps may be used for example. Preference is given to using unbleached chemical pulp, also known as unbleached kraft pulp. Suitable annual plants for producing fibrous materials include, for example, rice, wheat, sugarcane and kenaf. Furnishes can also be produced using wastepaper, which is either used alone or in admixture with other fibrous materials. The wastepaper may come from a de-inking process for example. However, the wastepaper to be used need not be subjected to such a process. It is further also possible to proceed from fibrous mixtures of a primary material and recycled coated broke.

In the case of bleached or unbleached chemical pulp, a fibrous material having a freeness of 20 to 30 SR is usable. The general rule is to use a fibrous material having a freeness of about 30 SR, which is beaten during furnishmaking. Preference is given to using fibrous material having a freeness of ≦30 SR.

In the process of the present invention, the aqueous composition is preferably added first to the paper stock. This may be done by admixing the aqueous composition to the thick stuff (fiber concentration >15 g/l, e.g., in the range from 25 to 40 g/l up to 60 g/l) or preferably to a thin stuff (fiber concentration <15 g/l, e.g., in the range from 5 to 12 g/l). The point of admixture is preferably located upstream of the wires, but may also be located between a shearing stage and a screen or downstream thereof.

The water-soluble polymeric anionic compound is usually only admixed to the paper stock after the aqueous composition has been admixed, but may also be added to the paper stock at the same time as but separately from the aqueous composition. It is further also possible to admix the water-soluble polymeric anionic compound first and the aqueous composition thereafter.

In a particularly preferred version of the process, the aqueous composition is added to the paper stock before the filler is admixed.

The aqueous composition is preferably added in an amount comprising from 0.01 to 6 wt % of the polymer having primary amino groups and/or amidine groups (solids), based on fibrous material (solids). The aqueous composition is more preferably used in a ratio relative to the fibrous material that amounts to from 0.05 to 5 wt % of the polymer having primary amino groups and/or amidine groups (solids) based on the fibrous material (solids).

The water-soluble polymeric anionic compound is employed in the process of the present invention in an amount of, for example, 0.01 to 6.0 wt %, preferably 0.05 to 1.0 wt %, especially 0.1 to 0.5 wt %, based on dry paper stock.

The weight ratio of polymers having primary amino groups and/or amidine groups (solids) to the water-soluble polymeric anionic compounds is, for example, from 4:1 to 1:1 and preferably from 2:1 to 1:1.

Dry content as used in respect of paper and in respect of fibrous material is to be understood as meaning the ratio of the mass of a sample dried to constant mass at a temperature of (105±2)° C. under defined conditions, to the mass of the sample before drying. Dry content is typically reported as mass fractions in percent. Dry content is quantified using the thermal cabinet method of DIN EN ISO 638 DE. Dry content in respect of fibrous material can be used to determine the amount of fibrous material (solids).

Typical application rates for the aqueous composition are specified in terms of the polymer and range for example from 0.2 to 120 kg, preferably from 0.3 to 100 kg and particularly from 0.5 to 50 kg of at least the polymer having primary amino groups and/or amidine groups per metric ton of a dry fibrous material. The amounts used of the aqueous composition according to the present invention, based on the polymer having primary amino groups and/or amidine groups, is more preferably from 0.4 to 3 kg and preferably from 0.6 to 3 kg of polymer (solids) per metric ton of dry fibrous material.

The time during which the aqueous composition of the present invention acts on a purely fibrous/paper stock material from the time of addition to the time of sheet formation is for example in the range from 0.5 second to 2 hours, preferably in the range from 1.0 second to 15 minutes and more preferably in the range from 2 to 20 seconds.

The present invention utilizes fillers having an average particle size (volume average) ≦10 μm, preferably in the range from 0.3 to 5 μm and especially in the range from 0.5 to 2 μm. Average particle size (volume average) is generally quantified herein for the fillers and also the particles of the pulverulent composition by the method of quasi-elastic light scattering (DIN-ISO 13320-1) using, for example, a Mastersizer 2000 from Malvern Instruments Ltd.

The filler is added preferably after the aqueous composition of the present invention has been admixed. In one preferred embodiment, the admixture takes place at the stage at which the fibrous material is already in the form of thin stuff, i.e., at a fibrous concentration of 5 to 15 g/l.

In a further preferred embodiment, the filler is added to thick stuff as well as thin stuff, the ratio of the two admixtures (thick stuff admixture/thin stuff admixture) preferably being in the range from 5/1 to 1/5.

In addition to the aqueous composition of the present invention, customary paper auxiliaries may optionally be admixed to the paper stock, generally at a fibrous concentration of 5 to 15 g/l. Conventional paper auxiliaries include, for example, sizing agents, wet strength agents, cationic or anionic retention aids based on synthetic polymers and also dual systems, drainage aids, other dry strength enhancers, optical brighteners, defoamers, biocides and paper dyes. These conventional paper additives are usable in the customary amounts.

Useful sizing agents include alkyl ketene dimers (AKDs), alkenylsuccinic anhydrides (ASAs) and rosin size.

Useful retention aids include for example cationic polyacrylamides, cationic starch, cationic polyethyleneimine or cationic polyvinylamine. To achieve high filler retention, it is advisable to admix such retention aids as are admixable for example to thin stuff. Microparticulate systems are employed to further improve retention. Typical microparticulate systems are based on silica sols, bentonites and also mixtures but also on anionically crosslinked microparticles.

Dry strength enhancers are synthetic dry strength enhancers such as polyvinylamine, polyethyleneimine, glyoxylated polyacrylamide (PAM), or natural dry strength enhancers such as starches based on derivatized starches (cationic) or natural starches which are subjected to oxidative or enzymatic breakdown. To achieve high efficacy for dry strength enhancers, it is advisable to admix synthetic dry strength enhancers which are preferably admixed to thick stuff but are also admixable to thin stuff.

The papers obtained with the aqueous composition of the present invention have very good performance characteristics. Admixing the aqueous composition of the present invention leads to outstanding strengths, in particular dry strength. This makes possible the usage of smaller amounts of auxiliaries for the same grammage and desired strength and/or the production of paper of lower grammage for the same strength and hence a basis weight reduction. The comparatively high strength-enhancing effect further makes possible the usage of less costly fibers (e.g., increasing the wastepaper fraction in semi-pulp kraft liner, or increasing the proportion of chemithermal pulp in folding and/or food boxboard), raising the filler fraction in packaging papers and also graphic papers.

It is preferable to use aqueous compositions wherein the polymer having primary amino groups and/or amidine groups is a hydrolyzed N-vinylcarboxamide homopolymer, preferably having a ≧30 mol % degree of hydrolysis, for producing test liners.

In a likewise preferred embodiment, aqueous compositions comprising a polymer having primary amino groups and/or amidine groups selected from hydrolyzed copolymers of N-vinylcarboxamide with further neutral monoethylenically unsaturated monomers, hydrolyzed copolymers of N-vinylcarboxamide with anionic monoethylenically unsaturated monomers, hydrolyzed copolymers of N-vinylcarboxamide with cationic monoethylenically unsaturated monomers, are used for producing wood-free papers.

It is particularly preferable to use aqueous compositions wherein the polymer having primary amino groups and/or amidine groups is a partially or fully hydrolyzed copolymer of N-vinylcarboxamide with further neutral, anionic and/or cationic monoethylenically unsaturated monomers, wherein this monomer is selected from acrylonitrile, vinyl acetate, sodium acrylate, diallyldimethylammonium chloride, [3-(dimethylamino)propyl]acrylamide, N-[3-(dimethylamino)propyl]methacrylamide, [3-(trimethylammonio)propyl]acrylamide chloride and N-[3-(trimethylammonio)propyl]methacrylamide chloride, for producing wood-free papers.

It is believed—without wishing to be tied to this theory—that the underlying equilibrium between polymer having primary amino groups and/or amidine groups+cyclohexanedione and the crosslinked product formed from these two materials is shifted to the side of the crosslinked product at above pH 6. According to this theory, such a shift in equilibrium in the presence of the fibrous material involved in papermaking, where the pH is above 6, would have a strength-enhancing effect.

### EXAMPLES

The examples which follow further elucidate the present invention. The percentages in the examples are weight percent, unless otherwise stated.

The following abbreviations are used hereinbelow:

VFA: vinylformamide
NaAS: sodium acrylate
VAc: vinyl acetate
AN: acrylonitrile
DADMAC: diallyldimethylammonium chloride
PVFA: polyvinylformamide
Copo VFA/NaAS: copolymer of vinylformamide and sodium acrylate
Copo VFA/VAc: copolymer of vinylformamide and vinyl acetate
Copo VFA/AN/Na-ltaconat: copolymer of vinylformamide, acrylonitrile, sodium itaconate
Copo VFA/NaAS/AN: copolymer of vinylformamide, sodium acrylate and acrylonitrile
Copo VFA/DADMAC: copolymer of vinylformamide and DADMAC

K values were measured as described in H. Fikentscher, Cellulosechemie, volume 13, 48-64 and 71-74 under the particular conditions specified. The particulars between parentheses indicate the concentration of the polymer solution and the solvent.

Solids contents of polymers were quantified by 0.5 to 1.5 g of the polymer solution being distributed in a 4 cm diameter tin lid and then dried at 140° C. in a circulating air drying cabinet for two hours. The ratio of the mass of the sample after drying under the above conditions to the mass at sample taking is the solids content of the polymer.

The water used in the examples was completely ion-free.

Preparation of polymers having primary amino groups and/or amidine groups

The preparation was carried out in two or three steps:

1) polymerization
2) hydrolysis of polymers, and optionally
3) polymer-analogous reaction

### 1) Polymerizations

TABLE 1
Overview of polymerizations

| | Monomer composition in mol % | | | | | | | Solids |
|---|---|---|---|---|---|---|---|---|
| | | | | | | Na | | content |
| Example | VFA | Na acrylate | Vinyl acetate | Acrylonitrile | DADMAC | itaconate | K value | wt % |
| P1 | 100 | — | — | — | — | — | 45³⁾ | 36.4 |
| P2 | 100 | — | — | — | — | — | 90³⁾ | 19.7 |
| P3 | 100 | — | — | — | — | — | 120 | 12.6 |
| P4 | 80 | 20 | — | — | — | — | 86 | 21.5 |
| P5 | 70 | 30 | — | — | — | — | 55 | 24.0 |
| P6 | 70 | 30 | — | — | — | — | 85 | 16.0 |
| P7 | 70 | 30 | — | — | — | — | 90 | 23.8 |
| P8 | 70 | 30 | — | — | — | — | 122 | 15.9 |
| P9 | 60 | 40 | — | — | — | — | 92 | 25.0 |
| P10 | 70 | — | 30 | — | — | — | 84¹⁾ | 15.5 |
| P11 | 60 | — | 40 | — | — | — | 74¹⁾ | 15.7 |
| P12 | 50 | — | 50 | — | — | — | 68¹⁾ | 16.5 |
| P13 | 49.5 | — | — | 49.5 | — | 1 | 175²⁾ | 16.3 |
| P14 | 50 | 30 | — | 20 | — | — | 90 | 25.6 |
| P15 | 70 | — | — | — | 30 | — | 80 | 20.0 |

¹⁾K value quantified in formamide
²⁾K value quantified in DMSO
³⁾K value quantified in water

### Example P1 (VFA Homopolymer, K 45)

Feed 1 was provided by providing 423.1 g of N-vinylformamide (BASF).

Feed 2 was provided by dissolving 9.7 g of 2,2′-azobis(2-methylpropionamidine) dihydrochloride (Wako) in 112.0 g of water at room temperature.

A 2 l glass apparatus fitted with anchor stirrer, descending condenser, internal thermometer and nitrogen inlet tube was initially charged with 585.2 g of water and 4.6 g of 75 wt % phosphoric acid. About 8.2 g of 25 wt % aqueous sodium hydroxide solution were admixed at a speed of 100 rpm, attaining pH 6.6. The initial charge was heated to 80° C. and the pressure in the apparatus was reduced sufficiently for the reaction mixture to just start to boil at 80° C. (about 460 mbar). Feeds 1 and 2 were then started at the same time and admixed concurrently over a period of 3 hours at a constant 80° C. On completion of the admixture the reaction mixture was postpolymerized at 80° C. for a further three hours. During the entire polymerization and postpolymerization, about 100 g of water were distilled off. The batch was subsequently cooled down to room temperature under atmospheric pressure.

The product obtained was a slightly yellow, viscous solution having a solids content of 36.4 wt %. The K value of the polymer was 45 (1.0 wt % in water).

### Example P2 (VFA Homopolymer, K 90)

Feed 1 was provided by providing 234 g of N-vinylformamide.

Feed 2 was provided by dissolving 1.2 g of 2,2′-azobis(2-methylpropionamidine) dihydrochloride in 56.8 g of water at room temperature.

A 2 l glass apparatus fitted with anchor stirrer, descending condenser, internal thermometer and nitrogen inlet tube was initially charged with 1080.0 g of water and 2.5 g of 75 wt % phosphoric acid. 2.1 g of 25 wt % aqueous sodium hydroxide solution were admixed at a speed of 100 rpm, attaining pH 6.6. The initial charge was heated to 73° C. and the pressure in the apparatus was reduced sufficiently for the reaction mixture to just start to boil at 73° C. (about 350 mbar). Feeds 1 and 2 were then started at the same time. At a constant 73° C., feeds 1 and 2 were added, respectively, over one hour and 15 minutes and over 2 hours. On completion of the admixture of feed 2, the reaction mixture was postpolymerized at 73° C. for a further three hours. During the entire polymerization and postpolymerization, about 190 g of water were distilled off. The batch was subsequently cooled down to room temperature under atmospheric pressure.

The product obtained was a slightly yellow, viscous solution having a solids content of 19.7 wt %. The K value of the polymer was 90 (0.5 wt % in water)

### Example P3 (VFA Homopolymer, K 120)

Feed 1 was provided by dissolving 1.1 g of 2,2′-azobis(2-methylpropionamidine) dihydrochloride in 108.9 g of water at room temperature.

A 2 l glass apparatus fitted with anchor stirrer, descending condenser, internal thermometer and nitrogen inlet tube was initially charged with 961.0 g of water and 2.4 g of 75 wt % phosphoric acid. About 3.7 g of 25 wt % aqueous sodium hydroxide solution were admixed at a speed of 100 rpm, attaining pH 6.6. Subsequently, 222.2 g of N-vinylformamide were admixed. The initial charge was heated to 62° C. and the pressure in the apparatus was reduced sufficiently for the reaction mixture to just start to boil at 62° C. (about 220 mbar). Feed 1 was added over four hours at a constant 62° C. The reaction mixture was subsequently postpolymerized at 62° C. for two hours. During the entire polymerization and postpolymerization, about 200 g of water were distilled off. The batch was subsequently diluted with 670 g of water and cooled down to room temperature under atmospheric pressure.

The product obtained was a slightly yellow, viscous solution having a solids content of 12.6 wt %. The K value of the polymer was 120 (0.1 wt % in 5 wt % aqueous NaCl solution).

### Example P4 (VFA/Na Acrylate Copolymer 80 Mol %/20 Mol %, K 86)

Feed 1 was provided by providing a mixture of 293.7 g of water, 242.96 g of aqueous 32 wt % sodium acrylate solution adjusted to pH 6.4 and 237.2 g of N-vinylformamide.

Feed 2 was provided by dissolving 1.4 g of 2,2′-azobis(2-methylpropionamidine) dihydrochloride in 203.6 g of water at room temperature.

A 2 l glass apparatus fitted with anchor stirrer, descending condenser, internal thermometer and nitrogen inlet tube was initially charged with 659.4 g of water and 3.5 g of 75 wt % phosphoric acid. 6.0 g of 25 wt % aqueous sodium hydroxide solution were admixed at a speed of 100 rpm, attaining pH 6.6. The initial charge was heated to 80° C. and the pressure in the apparatus was reduced sufficiently for the reaction mixture to just start to boil at 80° C. (about 460 mbar). Feeds 1 and 2 were then started at the same time. At a constant 80° C., feeds 1 and 2 were added, respectively, over two hours and over 2.5 hours. On completion of the admixture of feed 2, the reaction mixture was postpolymerized at 80° C. for a further 2.5 hours. During the entire polymerization and postpolymerization, about 170 g of water were distilled off. The batch was subsequently cooled down to room temperature under atmospheric pressure.

The product obtained was a slightly yellow, viscous solution having a solids content of 21.5 wt %. The K value of the copolymer was 86 (0.5 wt % in 5 wt % aqueous NaCl solution).

### Example P5 (VFA/Na Acrylate Copolymer=70 Mol %/30 Mol %, K 55)

Feed 1 was provided by providing a mixture of 147.3 g of water, 317.6 g of aqueous 32 wt % sodium acrylate solution adjusted to pH 6.4 and 181.0 g of N-vinylformamide.

Feed 2 was provided by dissolving 5.1 g of 2,2′-azobis(2-methylpropionamidine) dihydrochloride in 165.9 g of water at room temperature.

A 2 l glass apparatus fitted with anchor stirrer, descending condenser, internal thermometer and nitrogen inlet tube was initially charged with 573.4 g of water and 3.0 g of 75 wt % phosphoric acid. 5.2 g of 25 wt % aqueous sodium hydroxide solution were admixed at a speed of 100 rpm, attaining pH 6.6. The initial charge was heated to 80° C. and the pressure in the apparatus was reduced sufficiently for the reaction mixture to just start to boil at 80° C. (about 460 mbar). Feeds 1 and 2 were then started at the same time. At a constant 80° C., feeds 1 and 2 were added, respectively, over two hours and over 2.5 hours. On completion of the admixture of feed 2, the reaction mixture was postpolymerized at 80° C. for a further 2.5 hours. During the entire polymerization and postpolymerization, about 170 g of water were distilled off. The batch was subsequently cooled down to room temperature under atmospheric pressure.

The product obtained was a slightly yellow, viscous solution having a solids content of 24.0 wt %. The K value of the copolymer was 55 (0.5 wt % in 5 wt % aqueous NaCl solution).

### Example P6 (VFA/Na Acrylate Copolymer=70 Mol %/30 Mol %, K 85)

Feed 1 was provided by providing a mixture of 340.0 g of water, 176.5 g of aqueous 32 wt % sodium acrylate solution adjusted to pH 6.4 and 100.6 g of N-vinylformamide.

Feed 2 was provided by dissolving 5.8 g of 2,2′-azobis(2-methylpropionamidine) dihydrochloride in 164.2 g of water at room temperature.

Feed 3 was provided by dissolving 5.8 g of 2,2′-azobis(2-methylpropionamidine) dihydrochloride in 164.2 g of water at room temperature.

A 2 l glass apparatus fitted with anchor stirrer, descending condenser, internal thermometer and nitrogen inlet tube was initially charged with 380 g of water and 1.2 g of 85 wt % phosphoric acid. 4.2 g of 25 wt % aqueous sodium hydroxide solution were admixed at a speed of 100 rpm, attaining pH 6.6. The initial charge was heated to 80° C. and the pressure in the apparatus was reduced sufficiently for the reaction mixture to just start to boil at 80° C. (about 450 mbar). Feeds 1 and 2 were then started at the same time and added concurrently over 2 h. The reaction mixture was subsequently postpolymerized at 80° C. for a further hour. Feed 3 was then admixed over 5 min, followed by a further two hours of postpolymerization at 80° C. During the entire polymerization and postpolymerization, about 100 g of water were distilled off. The batch was subsequently cooled down to room temperature under atmospheric pressure.

The product obtained was a slightly yellow, viscous solution having a solids content of 16.0 wt %. The K value of the copolymer was 85 (determined at 0.5 wt % in 5 wt % aqueous NaCl).

### Example P7 (VFA/Na Acrylate Copolymer=70 Mol %/30 Mol %, K 90)

Feed 1 was provided by providing a mixture of 100.0 g of water, 224.6 g of aqueous 32 wt % sodium acrylate solution adjusted to pH 6.4 and 128.0 g of N-vinylformamide.

Feed 2 was provided by dissolving 0.9 g of 2,2′-azobis(2-methylpropionamidine) dihydrochloride in 125.8 g of water at room temperature.

A 2 l glass apparatus fitted with anchor stirrer, descending condenser, internal thermometer and nitrogen inlet tube was initially charged with 407 g of water and 1.9 g of 85 wt % phosphoric acid. About 3.7 g of 25 wt % aqueous sodium hydroxide solution were admixed at a speed of 100 rpm, attaining pH 6.6. The initial charge was heated to 80° C. and the pressure in the apparatus was reduced sufficiently for the reaction mixture to just start to boil at 80° C. (about 450 mbar). Feeds 1 and 2 were then started at the same time. At a constant 80° C., feeds 1 and 2 were added, respectively, over 1.5 h and over 2.5 hours. On completion of the admixture of feed 2, the reaction mixture was postpolymerized at 80° C. for a further 2.5 hours. During the entire polymerization and postpolymerization, about 143 g of water were distilled off. The batch was subsequently cooled down to room temperature under atmospheric pressure.

The product obtained was a slightly yellow, viscous solution having a solids content of 23.8 wt %. The K value of the copolymer was 90 (0.5 wt % in 5 wt % aqueous NaCl solution).

### Example P8 (VFA/Na Acrylate Copolymer=70 Mol %/30 Mol %, K 122)

Feed 1 was provided by providing a mixture of 330.0 g of water, 217.8 g of aqueous 32 wt % sodium acrylate solution adjusted to pH 6.4 and 124.2 g of N-vinylformamide.

Feed 2 was provided by dissolving 0.3 g of 2,2′-azobis(2-methylpropionamidine) dihydrochloride in 66.8 g of water at room temperature.

Feed 3 was provided by dissolving 0.2 g of 2,2′-azobis(2-methylpropionamidine) dihydrochloride in 17.4 g of water at room temperature.

A 2 l glass apparatus fitted with anchor stirrer, descending condenser, internal thermometer and nitrogen inlet tube was initially charged with 668.3 g of water and 1.9 g of 75 wt % phosphoric acid. 3.1 g of 25 wt % aqueous sodium hydroxide solution were admixed at a speed of 100 rpm, attaining pH 6.6. The initial charge was heated to 73° C. and the pressure in the apparatus was reduced sufficiently for the reaction mixture to just start to boil at 73° C. (about 340 mbar). Feeds 1 and 2 were then started at the same time. At a constant 73° C., feeds 1 and 2 were added, respectively, over 2 hours and over 3 hours. On completion of the admixture of feed 2, the reaction mixture was postpolymerized at 73° C. for a further 2 hours. Feed 3 was then admixed over 5 min, followed by a further two hours of postpolymerization at 73° C. During the entire polymerization and postpolymerization, about 190 g of water were distilled off. The batch was subsequently cooled down to room temperature under atmospheric pressure.

The product obtained was a slightly yellow, viscous solution having a solids content of 15.9 wt %. The K value of the copolymer was 122 (0.1 wt % in 5 wt % aqueous NaCl solution).

### Example P9 (VFA/Na Acrylate Copolymer=60 Mol %/40 Mol %, K 92)

Feed 1 was provided by providing a mixture of 423.5 g aqueous 32 wt % sodium acrylate solution adjusted to pH 6.4 and 155.1 g of N-vinylformamide.

Feed 2 was provided by dissolving 2.1 g of 2,2′-azobis(2-methylpropionamidine) dihydrochloride in 227.9 g of water at room temperature.

A 2 l glass apparatus fitted with anchor stirrer, descending condenser, internal thermometer and nitrogen inlet tube was initially charged with 573.4 g of water and 3.0 g of 85 wt % phosphoric acid. 5.2 g of 25 wt % aqueous sodium hydroxide solution were admixed at a speed of 100 rpm, attaining pH 6.6. The initial charge was heated to 77° C. and the pressure in the apparatus was reduced sufficiently for the reaction mixture to just start to boil at 77° C. (about 450 mbar). Feeds 1 and 2 were then started at the same time. At a constant 77° C., feeds 1 and 2 were added, respectively, over 1.5 h and over 2.5 hours. On completion of the admixture of feed 2, the reaction mixture was postpolymerized at 80° C. for a further 2.5 hours. During the entire polymerization and postpolymerization, about 200 g of water were distilled off. The batch was subsequently cooled down to room temperature under atmospheric pressure.

The product obtained was a slightly yellow, viscous solution having a solids content of 25.0 wt %. The K value of the copolymer was 92 (0.5 wt % in 5 wt % aqueous NaCl solution).

### Example P10 (VFA/VAc Copolymer=70 Mol %/30 Mol %, K 84)

Feed 1 was provided by providing 76.5 g of vinyl acetate.

Feed 2 was provided by dissolving 0.4 g of 2,2′-azobis(2-methylpropionamidine) dihydrochloride in 98.2 g of water at room temperature.

Feed 3 was provided by dissolving 0.1 g of 2,2′-azobis(2-methylpropionamidine) dihydrochloride in 44.7 g of water at room temperature.

Feed 4 was provided by providing 750 g of water.

A 2 l glass apparatus fitted with anchor stirrer, reflux condenser, internal thermometer and nitrogen inlet tube was initially charged with 352.5 g of water, 2.2 g of 85 wt % phosphoric acid and 22.4 g of a 10 wt % aqueous Mowiol 44-88 solution. 4.0 g of 25 wt % aqueous sodium hydroxide solution were admixed at a speed of 100 rpm such that a pH of 6.5 was attained. The initial charge was admixed with 149.0 g of N-vinylformamide and subjected to the introduction of nitrogen at 3 l/h for half an hour to remove oxygen present. In the meantime, the initial charge was heated to 65° C. Feed 1 was then admixed over 5 minutes, followed by feed 2 over 5 h. 1.0 h after feed 2 was started, feed 4 is additionally started and admixed over 2.5 hours. On completion of feed 2, the reaction mixture was postpolymerized at 65° C. for one hour, then admixed with feed 3 over 5 minutes and heated to 70° C. Postpolymerization was continued at 70° C. for a further 2 hours. Thereafter, the reflux condenser is replaced by a descending condenser. The pressure in the apparatus was reduced to 580 mbar and about 68 g of water were distilled off at 80° C. The product was cooled down to room temperature under atmospheric pressure.

The product obtained was a finely divided white suspension having a solids content of 15.5 wt %. The K value of the copolymer was 84 (0.5 wt % in formamide).

### Example P11 (VFA/VAc Copolymer=60 Mol %/40 Mol %, K 74)

Feed 1 was provided by providing 100.1 g of vinyl acetate.

Feed 2 was provided by dissolving 0.4 g of 2,2′-azobis(2-methylpropionamidine) dihydrochloride in 98.2 g of water at room temperature.

Feed 3 was provided by dissolving 0.1 g of 2,2′-azobis(2-methylpropionamidine) dihydrochloride in 44.7 g of water at room temperature.

Feed 4 was provided by providing 750 g of water.

A 2 l glass apparatus fitted with anchor stirrer, reflux condenser, internal thermometer and nitrogen inlet tube was initially charged with 352.8 g of water, 2.2 g of 85 wt % phosphoric acid and 22.4 g of a 10 wt % aqueous Mowiol 44-88 solution. 4.0 g of 25 wt % aqueous sodium hydroxide solution were admixed at a speed of 100 rpm to obtain a pH of 6.5. The initial charge was admixed with 125.2 g of N-vinylformamide and subjected to the introduction of nitrogen at 3 l/h for half an hour to remove oxygen present. In the meantime, the initial charge was heated to 65° C. Feed 1 was then admixed over 5 minutes, followed by feed 2 over 5 h. 1.5 h after feed 2 was started, feed 4 is additionally started and admixed over 2.5 hours. On completion of feed 2, the reaction mixture was postpolymerized at 65° C. for one hour, then admixed with feed 3 over 5 minutes and heated to 70° C. Postpolymerization was continued at 70° C. for a further 2 hours. Thereafter, the reflux condenser is replaced by a descending condenser. The pressure in the apparatus was reduced to 540 mbar and about 102 g of water were distilled off at 80° C. The product was cooled down to room temperature under atmospheric pressure.

The product obtained was a finely divided white suspension having a solids content of 15.7 wt %. The K value of the copolymer was 74 (0.5 wt % in formamide).

### Example P12 (VFA/VAc Copolymer=50 Mol %/50 Mol %, K 68)

Feed 1 was provided by providing 127.3 g of vinyl acetate.

Feed 2 was provided by dissolving 0.5 g of 2,2′-azobis(2-methylpropionamidine) dihydrochloride in 101.8 g of water at room temperature.

Feed 3 was provided by dissolving 0.1 g of 2,2′-azobis(2-methylpropionamidine) dihydrochloride in 46.4 g of water at room temperature.

Feed 4 was provided by providing 750 g of water.

A 2 l glass apparatus fitted with anchor stirrer, reflux condenser, internal thermometer and nitrogen inlet tube was initially charged with 338.4 g of water, 2.2 g of 85 wt % phosphoric acid and 23.2 g of a 10 wt % aqueous Mowiol 44-88 solution. 4.0 g of 25 wt % aqueous sodium hydroxide solution were admixed at a speed of 100 rpm such that a pH of 6.5 was attained. The initial charge was admixed with 106.2 g of N-vinylformamide and subjected to the introduction of nitrogen at 3 l/h for half an hour to remove oxygen present. In the meantime, the initial charge was heated to 65° C. Feed 1 was then admixed over 5 minutes, followed by feed 2 over 5 h. 2 h after feed 2 was started, feed 4 was additionally started and admixed over 2.5 hours. On completion of feed 2, the reaction mixture was postpolymerized at 65° C. for 1 hour, then admixed with feed 3 over 5 minutes and heated to 70° C. Postpolymerization was continued at 70° C. for a further 2 hours. Thereafter, the reflux condenser is replaced by a descending condenser. The pressure in the apparatus was reduced to 540 mbar and about 200 g of water were distilled off at 80° C. The vacuum was broken and the product was cooled down to room temperature.

The product obtained was a finely divided white suspension having a solids content of 16.5 wt %. The K value of the copolymer was 68 (0.5 wt % in formamide).

### Example P13 (VFA/AN/Na Itaconate Copolymer=49.5 Mol %/49.5 Mol %/1.0 Mol %, K 175)

Feed 1 was provided by providing 221.3 g of acrylonitrile.

Feed 2 was provided by providing 299.3 g of N-vinylformamide.

Feed 3 was provided by dissolving 0.7 g of 2,2′-azobis(2-methylpropionamidine) dihydrochloride in 128.8 g of water at room temperature.

A 2 l glass apparatus fitted with anchor stirrer, reflux condenser, internal thermometer and nitrogen inlet tube was initially charged with 1600.0 g of water, 5.2 g of 75 wt % phosphoric acid, 26.0 g of Luviskol K90 polyvinylpyrrolidone (BASF) and 154.7 g of 7 wt % aqueous itaconic acid solution. 37.4 g of 25 wt % aqueous sodium hydroxide solution were admixed at a speed of 100 rpm such that a pH of 6.8 was attained. Nitrogen was introduced into the initial charge at 10 l/h for half an hour to remove existing oxygen. In the meantime, the initial charge was heated to 60° C. Feeds 1 to 3 were then started at the same time. The addition at a constant 60° C. took 3.5 hours for feed 1, three hours for feed 2 and 4 h for feed 3. The reaction mixture was then postpolymerized at 60° C. for a further 2.5 hours.

Then, 546 g of water were admixed and the reflux condenser was replaced by a descending condenser. The pressure in the apparatus was reduced to 220 mbar and 552 g of water were distilled off at 64° C. The product was cooled down to room temperature under atmospheric pressure.

The product obtained was a finely divided white suspension having a solids content of 16.3 wt %. The K value of the copolymer was 175 (0.1 wt % in DMSO).

### Example P14 (VFA/Na Acrylate/AN Copolymer=50 Mol %/30 Mol %/20 Mol %, K 90)

Feed 1 was provided by providing 342.7 g of 32 wt % aqueous sodium acrylate solution.

Feed 2 was provided by providing 139.5 g of N-vinylformamide.

Feed 3 was provided by providing 41.2 g of acrylonitrile.

Feed 4 was provided by dissolving 1.0 g of 2,2′-azobis(2-methylpropionamidine) dihydrochloride in 114.8 g of water at room temperature.

A 2 l glass apparatus fitted with anchor stirrer, reflux condenser, internal thermometer and nitrogen inlet tube was initially charged with 540.0 g of water and 2.7 g of 75 wt % phosphoric acid. 4.0 g of 25 wt % aqueous sodium hydroxide solution were admixed at a speed of 100 rpm such that a pH of 6.7 was attained. Nitrogen was introduced into the initial charge at 10 l/h for half an hour to remove the oxygen present. In the meantime, the initial charge was heated to 72° C. Feeds 1 to 4 were then started at the same time. The addition at a constant 72° C. took two hours for feed 1, 1.3 h for feed 2, 2.0 h for feed 3 and three hours for feed 4. The reaction mixture was then postpolymerized at 72° C. for a further 2.5 h.

Then, 121 g of water were admixed and the reflux condenser was replaced by a descending condenser. The pressure in the apparatus was reduced to 320 mbar and 121 g of water were distilled off at 72° C. The product was cooled down to room temperature under atmospheric pressure.

The product obtained was a slightly cloudy, viscous solution having a solids content of 25.6 wt %. The K value of the copolymer was 90 (0.5 wt % in 5 wt % aqueous NaCl solution).

### Example P15 (VFA/DADMAC Copolymer=70 Mol %/30 Mol %, K 80)

Feed 1 was provided by providing 119.1 g of N-vinylformamide.

Feed 2 was provided by dissolving 2.1 g of 2,2′-azobis(2-methylpropionamidine) dihydrochloride in 88.2 g of water at room temperature.

A 2 l glass apparatus fitted with anchor stirrer, descending condenser, internal thermometer and nitrogen inlet tube was initially charged with 202.2 g of water and 2.2 g of 85 wt % phosphoric acid. 3.0 g of 25 wt % aqueous sodium hydroxide solution were admixed at a speed of 100 rpm to obtain a pH of 6.5. Then, 176.8 g of a 65 wt % aqueous solution of diallyldimethylammonium chloride (Aldrich) were mixed in. Nitrogen was passed into the initial charge at 10 l/h for half an hour to remove the oxygen present. In the meantime, the initial charge was heated to 66° C. The pressure in the apparatus was reduced to about 240 mbar, so the reaction mixture just began to boil at 66° C. Feeds 1 and 2 were then started at the same time. The addition at a constant 66° C. took two hours for feed 1 and 4 hours for feed 2. On completion of the admixture of feed 2, the reaction mixture was postpolymerized at 66° C. for a further hour. Pressure and internal temperature were then raised to 360 mbar and 75° C. respectively and the mixture was subjected to a postpolymerization at 74° C. for a further two hours. The reaction mixture was still boiling under these conditions. About 90 g of water were distilled off during the entire polymerization and postpolymerization. Then, 690 g of water were admixed and the batch was cooled down to room temperature under atmospheric pressure.

The product obtained was a slightly yellow viscous solution having a solids content of 20%. The K value of the copolymer was 80 (1 wt % in 5 wt % aqueous NaCl solution).

### 2. Hydrolyses

The hydrolyses described hereinbelow in Examples H1 to H24 are collated in table 2.

TABLE 2
Reaction conditions and polymer used for hydrolysis

| | | | | | | Content | |
|---|---|---|---|---|---|---|---|
| | | | | | | of prim. | |
| | | | | Degree of | | amine + | |
| | Starting | Hydrolysis | Amount⁵⁾ | hydrolysis | PG | amidine | |
| Ex. | polymer | agent | [mol %] | [mol %] | [wt %] | [meq/g]⁶⁾ | Comments |
| H1 | P1 | NaOH | 75 | 70 | 11.4 | 13.4 | |
| H2 | P2 | NaOH | 120 | 100 | 7.8 | 22.7 | |
| H3 | P2 | NaOH | 73 | 70 | 9.5 | 13.4 | |
| H4 | P2 | NaOH | 50 | 50 | 11.8 | 8.7 | |
| H5 | P2 | NaOH | 40 | 40 | 10.3 | 6.6 | |
| H6 | P2 | NaOH | 36 | 35 | 10.6 | 5.7 | |
| H7 | P3 | NaOH | 50 | 48 | 7.9 | 8.3 | |
| H8 | P4 | NaOH | 50 | 52 | 13.1 | 7.0 | |
| H9 | P4 | NaOH | 110 | 100 | 9.8 | 16.2 | |
| H10 | P5 | NaOH | 120 | 100 | 10.9 | 12.4 | |
| H11 | P5 | NaOH | 50 | 52 | 14.5 | 6.0 | |
| H12 | P6 | NaOH | 120 | 100 | | 13.4 | |
| H13 | P7 | NaOH | 110 | 100 | 10.1 | 13.4 | |
| H14 | P7 | NaOH | 45 | 50 | 10.9 | 5.7 | |
| H15 | P8 | HCl | 43 | 50 | 10.6 | 5.7 | ²⁾ |
| H16 | P8 | NaOH | 110 | 100 | 5.9 | 13.4 | |
| H17 | P8 | NaOH | 51 | 50 | 7.0 | 5.7 | |
| H18 | P9 | NaOH | 110 | 100 | 12.6 | 11.0 | |
| H19 | P10 | NaOH | 120 | 100¹⁾ | 6.4 | 15.9 | ³⁾ |
| H20 | P11 | NaOH | 120 | 100¹⁾ | 6.4 | 13.6 | ³⁾ |
| H21 | P12 | NaOH | 120 | 100¹⁾ | 6.6 | 11.4 | ³⁾ |
| H22 | P13 | HCl | 100 | 98 | 5.6 | 9.8 | ⁴⁾ |
| H23 | P14 | HCl | 120 | 100 | 13.9 | 9.3 | ²⁾ |
| H24 | P15 | NaOH | 100 | 99 | 11.0 | 10.3 | |

PG: polymer content without counter-ion
¹⁾The degree of hydrolysis of the vinyl acetate was >95%.
²⁾The required amount of acid was chosen such that the sodium acrylate units in the polymer were additionally protonated.
³⁾The required amount of aqueous sodium hydroxide solution was chosen such that the vinyl acetate units in the molecule were completedly hydrolyzed.
⁴⁾The required amount of acid was chosen such that the sodium itaconate units in the polymer were additionally protonated.
⁵⁾Amount of hydrolysis agent in mol % based on the molar vinylformamide quantity used for the starting polymer.
⁶⁾Combined content of primary amino groups and/or amidine units in 1 g of polymer without counter-ion.

The degree of hydrolysis is the mol % fraction of hydrolyzed VFA units, based on the VFA units originally present in the polymer.

The degree of hydrolysis of the hydrolyzed homopolymers/copolymers of N-vinylformamide was quantified by enzymatic analysis of the formates/formic acid released in the hydrolysis (test kit from Boehringer Mannheim).

The degree of hydrolysis of hydrolyzed polymers bearing vinyl acetate units was quantified in a similar manner by using an analogous test kit from Boehringer Mannheim for the released acetic acid/acetates.

The polymer content without counter-ions indicates the wt % of polymer in the aqueous solution without inclusion of counter-ions. The polymer content without counter-ions represents the sum total of the proportional parts by weight of all structural units of the polymer in g which are present in 100 g of the solution. The polymer content without counter-ions is determined arithmetically. Potentially charge-bearing structural units are included in the charged form, i.e., for instance amino groups in the protonated form and acid groups in the deprotonated form. Counter-ions of charged structural units such as Na, chloride, phosphate, formate, acetate, etc. are not included. The calculation can be performed for any one batch by using the usage amounts of monomers, the degree of hydrolysis and any fraction which has been converted in a polymer-analogous manner to determine the molar amounts of the polymer's structural units present at the end of the reaction and convert them arithmetically, by means of the molar masses of the structural units, into the proportional parts by weight. The sum total of the proportional parts by weight represents the overall amount of polymer in this batch. The polymer content without counter-ion follows from the ratio of the overall amount of polymer to the overall mass of the batch.

The combined content of primary amino groups and amidine groups is obtainable in a manner similar to the procedure described above for the polymer content. The usage amounts of monomers, the analytically quantified degree of hydrolysis, the ratio of amidine groups to primary amino groups which is quantified by ¹³C NMR spectroscopy and, where appropriate, the fraction which was converted in a polymer-analogous manner are used to determine the molar composition of the polymer's structural units present at the end of the reaction. The molar mass of the individual structural units can be used to calculate therefrom the molar fraction of primary amino groups and/or amidine units in meq which are present in 1 g of polymer.

### Example H1

250.0 g of the polymer solution obtained by P1 were placed in a 500 ml four-neck flask fitted with blade stirrer, internal thermometer, dropping funnel and reflux condenser, admixed with 6.4 g of 40 wt % aqueous sodium bisulfite solution, and then heated to 80° C., at a stirrer speed of 80 rpm. Then, 147.8 g of 25 wt % aqueous sodium hydroxide solution were admixed. The mixture was maintained at 80° C. for three hours. The product obtained was cooled down to room temperature and adjusted to pH 2.0 with 163.1 g of 37 wt % hydrochloric acid.

A slightly yellow polymer solution was obtained. The degree of hydrolysis of the vinylformamide units was 70 mol %.

### Example H2

300.0 g of the polymer solution obtained by P2 were placed in a 1 l four-neck flask fitted with blade stirrer, internal thermometer, dropping funnel and reflux condenser and heated to 80° C. at a stirrer speed of 80 rpm. Then, 157.3 g of 25 wt % aqueous sodium hydroxide solution were admixed. The mixture was maintained at 80° C. for three hours. The product obtained was cooled down to room temperature.

A slightly yellow polymer solution was obtained. The degree of hydrolysis of the vinylformamide units was 100 mol %.

### Example H 3

700.0 g of the polymer solution obtained by P2 were placed in a 2 l three-neck flask fitted with blade stirrer, internal thermometer, dropping funnel and reflux condenser, admixed with 9.8 g of 40 wt % aqueous sodium bisulfite solution, and then heated to 80° C., at a stirrer speed of 80 rpm. Then, 219.3 g of 25 wt % aqueous sodium hydroxide solution were admixed. The mixture was maintained at 80° C. for three hours. The product obtained was cooled down to room temperature and adjusted to pH 7.0 with 102.1 g of 37 wt % hydrochloric acid.

A slightly yellow polymer solution was obtained. The degree of hydrolysis of the vinylformamide units was 70 mol %.

### Example H 4

400.0 g of the polymer solution obtained by P2 were placed in a 1 l four-neck flask fitted with blade stirrer, internal thermometer, dropping funnel and reflux condenser and heated to 80° C. at a stirrer speed of 80 rpm. Then, 87.4 g of 25 wt % aqueous sodium hydroxide solution were admixed. The mixture was maintained at 80° C. for three hours. The product obtained was cooled down to room temperature and adjusted to pH 7.0 with 39.8 g of 37 wt % hydrochloric acid.

A slightly yellow polymer solution was obtained. The degree of hydrolysis of the vinylformamide units was 50 mol %.

### Example H 5

136.1 g of the polymer solution obtained by P2 were placed in a 500 ml four-neck flask fitted with blade stirrer, internal thermometer, dropping funnel and reflux condenser, admixed with 1.9 g of 40 wt % aqueous sodium bisulfite solution, and then heated to 80° C., at a stirrer speed of 80 rpm. Then, 23.8 g of 25 wt % aqueous sodium hydroxide solution were admixed. The mixture was maintained at 80° C. for 4 hours. The product obtained was cooled down to room temperature and adjusted to pH 3.0 with 24.7 g of 37 wt % hydrochloric acid.

A slightly yellow polymer solution was obtained. The degree of hydrolysis of the vinylformamide units was 40 mol %.

### Example H 6

603.3 g of the polymer solution obtained by P2 were placed in a 1 l four-neck flask fitted with blade stirrer, internal thermometer, dropping funnel and reflux condenser, admixed with 8.6 g of 40 wt % aqueous sodium bisulfite solution, and then heated to 80° C., at a stirrer speed of 80 rpm. Then, 94.9 g of 25% aqueous sodium hydroxide solution were admixed. The mixture was maintained at 80° C. for 4 hours. The product obtained was cooled down to room temperature and adjusted to pH 3.0 with 31.7 g of 37 wt % hydrochloric acid.

A slightly yellow polymer solution was obtained. The degree of hydrolysis of the polymerized vinylformamide units was 35 mol %.

### Example H 7

250.0 g of the polymer solution obtained by P3 were placed in a 500 ml four-neck flask fitted with blade stirrer, internal thermometer, dropping funnel and reflux condenser, admixed with 2.3 g of 40 wt % aqueous sodium bisulfite solution, and then heated to 80° C., at a stirrer speed of 80 rpm. Then, 34.7 g of 25 wt % aqueous sodium hydroxide solution were admixed. The mixture was maintained at 80° C. for three hours. The product obtained was cooled down to room temperature and adjusted to pH 3.0 with 31.7 g of 37 wt % hydrochloric acid.

A slightly yellow polymer solution was obtained. The degree of hydrolysis of the vinylformamide units was 48 mol %.

### Example H 8

300.0 g of the polymer solution obtained by P4 were placed in a 500 ml four-neck flask fitted with blade stirrer, internal thermometer, dropping funnel and reflux condenser, admixed with 3.5 g of 40 wt % aqueous sodium bisulfite solution, and then heated to 80° C., at a stirrer speed of 80 rpm. Then, 53.6 g of 25 wt % aqueous sodium hydroxide solution were admixed. The mixture was maintained at 80° C. for three hours. The product obtained was cooled down to room temperature and adjusted to pH 7.5 with 24.1 g of 37 wt % hydrochloric acid.

A slightly yellow polymer solution was obtained. The degree of hydrolysis of the vinylformamide units was 52 mol %.

### Example H 9

1006.0 g of the polymer solution obtained by P4 were placed in a 2 l four-neck flask fitted with blade stirrer, internal thermometer, dropping funnel and reflux condenser, admixed with 11.7 g of 40 wt % aqueous sodium bisulfite solution, and then heated to 80° C., at a stirrer speed of 80 rpm. Then, 395.4 g of 25 wt % aqueous sodium hydroxide solution were admixed. The mixture was maintained at 80° C. for 7 hours. The product obtained was cooled down to room temperature.

A slightly yellow polymer solution was obtained. The degree of hydrolysis of the vinylformamide units was 100 mol %.

### Example H10

300.0 g of the polymer solution obtained by P5 were placed in a 500 ml four-neck flask fitted with blade stirrer, internal thermometer, dropping funnel and reflux condenser, admixed with 3.3 g of 40 wt % aqueous sodium bisulfite solution, and then heated to 80° C., at a stirrer speed of 80 rpm. Then, 120.4 g of 25 wt % aqueous sodium hydroxide solution were admixed. The mixture was maintained at 80° C. for three hours. The product obtained was cooled down to room temperature.

A slightly yellow polymer solution was obtained. The degree of hydrolysis of the vinylformamide units was 100 mol %.

### Example H11

300.0 g of the polymer solution obtained by P5 were placed in a 500 ml four-neck flask fitted with blade stirrer, internal thermometer, dropping funnel and reflux condenser, admixed with 3.3 g of 40 wt % aqueous sodium bisulfite solution, and then heated to 80° C., at a stirrer speed of 80 rpm. Then, 50.2 g of 25 wt % aqueous sodium hydroxide solution were admixed. The mixture was maintained at 80° C. for three hours. The product obtained was cooled down to room temperature and adjusted to pH 7.5 with 22.6 g of 37 wt % hydrochloric acid.

A slightly yellow polymer solution was obtained. The degree of hydrolysis of the vinylformamide units was 52 mol %.

### Example H12

600.0 g of the polymer solution obtained by P6 were placed in a 2 l four-neck flask fitted with blade stirrer, internal thermometer, dropping funnel and reflux condenser, admixed with 4.5 g of 40 wt % aqueous sodium bisulfite solution, and then heated to 80° C., at a stirrer speed of 80 rpm. Then, 150.0 g of 25% aqueous sodium hydroxide solution were admixed. The mixture was maintained at 80° C. for 7 hours. The product obtained was cooled down to room temperature.

A slightly yellow polymer solution was obtained. The degree of hydrolysis of the vinylformamide units was 100 mol %.

### Example H13

847.2 g of the polymer solution obtained by P7 were placed in a 2 l four-neck flask fitted with blade stirrer, internal thermometer, dropping funnel and reflux condenser, admixed with 9.3 g of 40 wt % aqueous sodium bisulfite solution, and then heated to 80° C., at a stirrer speed of 80 rpm. Then, 313.7 g of 25% aqueous sodium hydroxide solution were admixed. The mixture was maintained at 80° C. for 7 hours. The product obtained was cooled down to room temperature and adjusted to pH 8.5 with 117.0 kg of 37 wt % hydrochloric acid.

A slightly yellow polymer solution was obtained. The degree of hydrolysis of the vinylformamide units was 100 mol %.

### Example H14

846.5 g of the polymer solution obtained by P7 were placed in a 2 l four-neck flask fitted with blade stirrer, internal thermometer, dropping funnel and reflux condenser, admixed with 236.3 g of completely ion-free water and 9.3 g of 40 wt % aqueous sodium bisulfite solution, and then heated to 80° C., at a stirrer speed of 80 rpm. Then, 128.3 g of 25 wt % aqueous sodium hydroxide solution were admixed. The mixture was maintained at 80° C. for 5 hours. The product obtained was cooled down to room temperature and adjusted to pH 8.3 with 52.0 kg of 37 wt % hydrochloric acid.

A slightly yellow polymer solution was obtained. The degree of hydrolysis of the vinylformamide units was 50 mol %.

### Example H15

360.0 g of the polymer solution obtained by P8 were placed in a 500 ml four-neck flask fitted with blade stirrer, internal thermometer, dropping funnel and reflux condenser, admixed with 2.5 g of 40 wt % aqueous sodium bisulfite solution, and heated to 80° C. at a stirrer speed of 80 rpm. Then, 41.3 g of 37% hydrochloric acid were admixed. The mixture was maintained at 80° C. for three hours. The product obtained was cooled down to room temperature.

A slightly yellow polymer solution was obtained. The degree of hydrolysis of the vinylformamide units was 50 mol %.

### Example H16

638.4 g of the polymer solution obtained by P8 were placed in a 1 l four-neck flask fitted with blade stirrer, internal thermometer, dropping funnel and reflux condenser, admixed with 4.7 g of 40 wt % aqueous sodium bisulfite solution, and then heated to 80° C., at a stirrer speed of 80 rpm. Then, 158.3 g of 25 wt % aqueous sodium hydroxide solution were admixed. The mixture was maintained at 80° C. for 6 hours. The product obtained was cooled down to room temperature.

A slightly yellow polymer solution was obtained. The degree of hydrolysis of the vinylformamide units was 100 mol %.

### Example H17

1224.3 g of the polymer solution obtained by P8 were placed in a 2 l four-neck flask fitted with blade stirrer, internal thermometer, dropping funnel and reflux condenser, admixed with 704.4 g of completely ion-free water and 8.9 g of 40 wt % aqueous sodium bisulfite solution, and then heated to 80° C., at a stirrer speed of 80 rpm. Then, 140.4 g of 25 wt % aqueous sodium hydroxide solution were admixed. The mixture was maintained at 80° C. for 5 hours. And then cooled down to room temperature.

A slightly yellow polymer solution was obtained. The degree of hydrolysis of the vinylformamide units was 50 mol %.

### Example H18

1102.9 g of the polymer solution obtained by P9 were placed in a four-neck flask fitted with blade stirrer, internal thermometer, dropping funnel and reflux condenser, admixed with 10.5 g of 40 wt % aqueous sodium bisulfite solution, and then heated to 80° C., at a stirrer speed of 80 rpm. Then, 355.6 g of 25 wt % aqueous sodium hydroxide solution were admixed. The mixture was maintained at 80° C. for 7 hours and then cooled down to room temperature.

A slightly cloudy polymer solution was obtained. The degree of hydrolysis of the vinylformamide units was 100 mol %.

### Example H19

200.0 g of the polymer solution obtained by P10 were placed in a 500 ml four-neck flask fitted with blade stirrer, internal thermometer, dropping funnel and reflux condenser, admixed with 1.5 g of 40 wt % aqueous sodium bisulfite solution, and then heated to 80° C., at a stirrer speed of 80 rpm. Then, 73.4 g of 25 wt % aqueous sodium hydroxide solution were admixed. The mixture was maintained at 80° C. for three hours, and the suspension formed a solution. The product obtained was cooled down to room temperature.

A slightly cloudy polymer solution was obtained. The degree of hydrolysis of the vinylformamide units and of the vinyl acetate units was 100 mol % in both cases.

### Example H20

200.0 g of the polymer solution obtained by P10 were placed in a 500 ml four-neck flask fitted with blade stirrer, internal thermometer, dropping funnel and reflux condenser, admixed with 1.3 g of 40 wt % aqueous sodium bisulfite solution, and then heated to 80° C., at a stirrer speed of 80 rpm. Then, 72.0 g of 25 wt % aqueous sodium hydroxide solution were admixed. The mixture was maintained at 80° C. for three hours, and the suspension formed a solution. The product obtained was cooled down to room temperature.

A slightly cloudy polymer solution was obtained. The degree of hydrolysis of the vinylformamide units and of the vinyl acetate units was 100 mol % in both cases.

### Example H21

200.0 g of the polymer solution obtained by P12 were placed in a 500 ml four-neck flask fitted with blade stirrer, internal thermometer, dropping funnel and reflux condenser, admixed with 1.1 g of 40 wt % aqueous sodium bisulfite solution, and then heated to 80° C., at a stirrer speed of 80 rpm. Then, 72.8 g of 25 wt % aqueous sodium hydroxide solution were admixed. The mixture was maintained at 80° C. for three hours, and the suspension formed a solution. The product obtained was cooled down to room temperature.

A slightly cloudy polymer solution was obtained. The degree of hydrolysis of the vinylformamide units and of the vinyl acetate units was 100 mol % in both cases.

### Example H22

450.0 g of the polymer solution obtained by P13 were placed in a 1 l four-neck flask fitted with blade stirrer, internal thermometer, dropping funnel and reflux condenser and admixed at a stirrer speed of 80 rpm with 450 g of water and 2.8 g of 40 wt % aqueous sodium bisulfite solution and then with 54.6 g of 37% hydrochloric acid. The mixture was heated to the boil and refluxed for 4 hours. The product obtained was cooled down to room temperature.

A yellowish polymer solution having a solids content of 8.6 wt % was obtained. The degree of hydrolysis of the vinylformamide units was 98 mol %.

### Example H23

180.0 g of the polymer solution obtained by P14 were placed in a 500 ml four-neck flask fitted with blade stirrer, internal thermometer, dropping funnel and reflux condenser and admixed with 1.5 g of 40 wt % aqueous sodium bisulfite solution, and then heated to reflux, at a stirrer speed of 80 rpm. The mixture was admixed with 53.9 g of 37 wt % hydrochloric acid and refluxed for 8 hours. The product obtained was cooled down to room temperature.

A viscous, slightly cloudy polymer solution having a solids content of 22.5 wt % was obtained.

The degree of hydrolysis of the vinylformamide units was 100 mol %.

### Example H24

200.0 g of the polymer solution obtained by P15 were placed in a 500 ml four-neck flask fitted with blade stirrer, internal thermometer, dropping funnel and reflux condenser and heated to 80° C. at a stirrer speed of 80 rpm. Once 80° C. had been reached, first 1.4 g of 25 wt % aqueous sodium bisulfite solution and then 44.6 g of 25 wt % aqueous sodium hydroxide solution were added such that they became mixed in efficiently. The reaction mixture was maintained at 80° C. for 3 hours and then cooled down to room temperature. A viscous, slightly yellow polymer solution having a solids content of 22.7 wt % was obtained. The degree of hydrolysis of the vinylformamide units was 99 mol %.

### 3. Polymer-Analogous Conversions

The hereinbelow detailed polymer-analogous reactions are summarized in table 3. The polymer-analogous reactions were all carried out with starting polymer H2, i.e., a fully hydrolyzed homopolymer of vinylformamide (polyvinylamine having a 100 mol % degree of hydrolysis).

TABLE 3
Polymer-analogous conversions

| | | | | | | Content of |
|---|---|---|---|---|---|---|
| | | | | | | prim. |
| | | | | | | amine + |
| | Starting | | Reagent²⁾ | Conversion | | amidine |
| Example | polymer | Reagent | [mol %] | [mol %] | PG [wt %] | [meq/g]³⁾ |
| PA1 | H2 | acrylamide | 40 | >99 | 5.4 | 8.3 |
| PA2 | H2 | acrylamide | 66 | >99 | 13.3 | 3.7 |
| PA3 | H2 | benzyl | 10 | >99 | 8.2 | 17.0 |
| | | chloride | | | | |
| PA4 | H2 | acrylonitrile | 30 | >99 | 5.3 | 11.7 |
| PA5 | H2 | acrylonitrile | 60 | >98 | 6.6 | 5.3 |
| PA6 | H2 | QUAB 432¹⁾ | 1 | >99 | 4.5 | 21.2 |

¹⁾QUAB 342 alkylating agent (from SKW, Germany)
²⁾Amount of reagent used [mol %] based on prim. amino groups
³⁾Combined content of primary amino groups and/or amidine units in 1 g of polymer without counter-ion
PG: polymer content without counter-ion

The degree of conversion in the reactions hereinbelow was quantified by quantifying the residual reagent content of the end product. The methods used are specified in the respective examples.

### Example PA 1

250 g of the polymer solution obtained by H2 were initially charged to a 500 ml four-neck flask fitted with blade stirrer, internal thermometer, dropping funnel and reflux condenser. Under agitation (stirrer speed 80 rpm), the solution was diluted with 250 g of water and adjusted to pH 10 by admixture of about 17 g of 37 wt % hydrochloric acid. 18.9 g of 50 wt % aqueous acrylamide solution were added dropwise at room temperature and the solution obtained was gradually heated to 70° C. The solution was left at 70° C. for 6 hours and the established pH was maintained by admixture of 25 wt % aqueous sodium hydroxide solution. The solution was then cooled down to room temperature and adjusted to pH 8.3 by admixture of 10.2 g of 37 wt % hydrochloric acid.

The viscous solution obtained had a residual acrylamide content of 20 ppm (HPLC) and a 5.4 wt % polymer content without counter-ion.

### Example PA 2

850 g of the polymer solution obtained by H2 were initially charged to a 1 l four-neck flask fitted with blade stirrer, internal thermometer, dropping funnel and reflux condenser. Under agitation (stirrer speed 80 rpm), the solution was adjusted to pH 9 by admixture of about 79 g of 37 wt % hydrochloric acid. 148.9 g of 50 wt % aqueous acrylamide solution were added dropwise at room temperature and the reaction mixture obtained was gradually heated to 70° C. The solution was maintained at 70° C. for 6 hours and then cooled down to room temperature. Then the pH was adjusted to pH 8.4 by admixture of 3.7 g of 37 wt % hydrochloric acid.

The viscous solution obtained had a residual acrylamide content of 40 ppm (HPLC) and a 13.3 wt % polymer content without counter-ion.

### Example PA 3

200.0 g of the polymer solution obtained by H2 were initially charged to a 500 ml four-neck flask fitted with blade stirrer, internal thermometer, dropping funnel and reflux condenser. Under agitation (stirrer speed 80 rpm), 4.6 g of benzyl chloride were admixed. The dispersion obtained was heated to 65° C. and maintained at that temperature for three hours to form a clear, viscous solution having an 8.2 wt % polymer content without counter-ion. The residual benzyl chloride content (HPLC) was below the 10 ppm limit of detection.

### Example PA 4

200.0 g of the polymer solution obtained by H2 were initially charged to a 500 ml three-neck flask fitted with blade stirrer, internal thermometer, dropping funnel and reflux condenser. Under agitation (stirrer speed 80 rpm), 200 g of water were admixed first. Using 12.6 g of 37% hydrochloric acid, the pH was adjusted to 10 and then 5.9 g of acrylonitrile were admixed. The solution obtained was heated to 75° C., maintained at that temperature for 5 hours and then cooled down to room temperature. The viscous solution obtained had a residual acrylonitrile content (headspace GC) of 130 ppm. The polymer content without counter-ion was 5.3 wt %.

### Example PA 5

200.0 g of the polymer solution obtained by H2 were initially charged to a 500 ml four-neck flask fitted with blade stirrer, internal thermometer, dropping funnel and reflux condenser. Under agitation (stirrer speed 80 rpm), 200 g of water were admixed first. Using 12.6 g of 37 wt % hydrochloric acid, the pH was adjusted to 10 and then 11.8 g of acrylonitrile were admixed. The solution obtained was heated to 75° C., maintained at that temperature for 5 hours and then cooled down to room temperature. The viscous solution obtained had a residual acrylonitrile content (headspace GC) of 300 ppm. The polymer content without counter-ion was 6.6 wt %.

### Example PA 6

200.0 g of the polymer solution obtained by H2 were initially charged to a 500 ml four-neck flask fitted with blade stirrer, internal thermometer, dropping funnel and reflux condenser. Under agitation (stirrer speed 80 rpm), 120 g of water were first admixed, followed by 3.2 g of QUAB 342 (3-chloro-2-hydroxypropyllauryldimethylammonium chloride, alkylating agent from SKW, Germany). The solution obtained was heated to 66° C. and maintained at that temperature for 5 hours. Following this reaction time, complete conversion of the alkylating agent was detected using the Preβmann test. This was followed by cooling down to room temperature. The viscous solution obtained had a 4.5 wt % polymer content without counter-ion.

A description of the Preuβmann test procedure is found, for example, in EP 1651699 page 4 line 50 to page 5 line 20.

### Example SP 1

The polymer used was identical to the Hofmann degradation product referred to as C8 beta 2 in the table on page 13 of WO 2006/075115. It was prepared by reacting polyacrylamide with sodium hypochlorite in a molar ratio of 1:1 and aqueous sodium hydroxide solution, while the molar ratio of sodium hydroxide to sodium hypochlorite was 2:1.

The polymer content without counter-ion was 4.5% and the primary amino group content was 9.8 meq/g.

Preparation of Aqueous Compositions Used According to the Invention

### Examples EF1 to EF44

The general procedure for this was as follows:

250 g of the particular solution obtained for the polymer having primary amino groups and/or amidine groups (see table 4) were initially charged at room temperature to a 500 ml three-neck flask fitted with blade stirrer, pH electrode and dropping funnel. The pH reported in the table was then established by the admixture of 37 wt % hydrochloric acid or of 25 wt % sodium hydroxide solution. 1,4-Cyclohexanedione (from Aldrich) was then admixed in solid form. The amount of cyclohexanedione used is shown in table 4. The mixture was stirred at room temperature for two hours to completely dissolve the cyclohexanedione. The solution thus obtained was used for performance testing.

TABLE 4
Examples of aqueous compositions used according to the invention

| | | | | 1,4- | PG⁴⁾ |
|---|---|---|---|---|---|
| | | | | CHD³⁾ | [wt |
| Ex. | Starting polymer | | pH | [mol %] | %] |
| EF1 | H1 | PVFA, K 45; HG 70% | 2.0 | 15 | 13.3 |
| EF2 | H2 | PVFA, K 90; HG >95% | 1.0 | 8 | 6.2 |
| EF3 | H2 | PVFA, K 90; HG >95% | 1.0 | 5 | 6.0 |
| EF4 | H3 | PVFA, K 90; HG70% | 1.0 | 8 | 8.9 |
| EF5 | H4 | PVFA, K 90; HG50% | 3.0 | 2 | 10.0 |
| EF6 | H4 | PVFA, K 90; HG50% | 3.0 | 5 | 5.5 |
| EF7 | H4 | PVFA, K 90; HG50% | 3.0 | 8 | 9.8 |
| EF8 | H5 | PVFA, K 90; HG40% | 3.0 | 8 | 10.8 |
| EF9 | H6 | PVFA, K 90; HG35% | 3.0 | 8 | 11.1 |
| EF10 | H7 | PVFA, K 120; HG50% | 3.0 | 8 | 8.1 |
| EF11 | H8 | Copo VFA/NaAS = 80/20, K 90, | 3.0 | 8 | 12.5 |
| | | HG 50% | | | |
| EF12 | H9 | Copo VFA/NaAS = 80/20, K 90, | 1.4 | 5 | 7.9 |
| | | HG >95% | | | |
| EF13 | H10 | Copo VFA/NaAS = 70/30, K 55, | 3.0 | 15 | 9.9 |
| | | HG >95% | | | |
| EF14 | H11 | Copo VFA/NaAS = 70/30, K 55, | 3.0 | 15 | 15.5 |
| | | HG 52% | | | |
| EF15 | H12 | Copo VFA/NaAS = 70/30, K 85, | 3.0 | 5 | 11.5 |
| | | HG >95% | | | |
| EF16 | H13 | Copo VFA/NaAS = 70/30, K 90, | 2.0 | 2 | 8.4 |
| | | HG >95% | | | |
| EF17 | H13 | Copo VFA/NaAS = 70/30, K 90, | 2.0 | 5 | 8.4 |
| | | HG >95% | | | |
| EF18 | H13 | Copo VFA/NaAS = 70/30, K 90, | 2.0 | 8 | 8.5 |
| | | HG >95% | | | |
| EF19 | H14 | Copo VFA/NaAS = 70/30, K 90, | 4 | 1 | 10.5 |
| | | HG 50% | | | |
| EF20 | H14 | Copo VFA/NaAS = 70/30, K 90, | 4 | 2 | 10.6 |
| | | HG 50% | | | |
| EF21 | H14 | Copo VFA/NaAS = 70/30, K 90, | 4 | 5 | 10.7 |
| | | HG 50% | | | |
| EF22 | H14 | Copo VFA/NaAS = 70/30, K 90, | 4 | 8 | 11.0 |
| | | HG 50% | | | |
| EF23¹⁾ | H15 | Copo VFA/NaAS = 70/30, K 120, | 4 | 5 | 10.2 |
| | | HG 50% | | | |
| EF24 | H16 | Copo VFA/NaAS = 70/30, K 122, | 2.5 | 2 | 5.5 |
| | | HG >95% | | | |
| EF25 | H16 | Copo VFA/NaAS = 70/30, K 122, | 2.5 | 5 | 5.6 |
| | | HG >95% | | | |
| EF26 | H16 | Copo VFA/NaAS = 70/30, K 122, | 2.5 | 8 | 5.7 |
| | | HG >95% | | | |
| EF27 | H17 | Copo VFA/NaAS = 70/30, K 122, | 3 | 2 | 6.7 |
| | | HG 50% | | | |
| EF28 | H17 | Copo VFA/NaAS = 70/30, K 122, | 3 | 5 | 6.7 |
| | | HG 50% | | | |
| EF29 | H17 | Copo VFA/NaAS = 70/30, K 122, | 3 | 8 | 6.8 |
| | | HG 50% | | | |
| EF30 | H18 | Copo VFA/NaAS = 60/40, K 90, | 2.3 | 5 | 10.1 |
| | | HG >95% | | | |
| EF31²⁾ | H19 | Copo VFA/VAc = 70/30, K 84, | 1.0 | 5 | 5.4 |
| | | HG >95% | | | |
| EF32²⁾ | H20 | Copo VFA/VAc = 60/40, K 74, | 1.0 | 5 | 5.4 |
| | | HG >95% | | | |
| EF33²⁾ | H21 | Copo VFA/VAc = 50/50, K 684, | 1.0 | 5 | 5.4 |
| | | HG >95% | | | |
| EF34¹⁾ | H22 | Copo VFA/AN/Na itaconate = | 1.5 | 5 | 5.6 |
| | | 49.5/49.5/1.0, | | | |
| | | K 174, HG >95% | | | |
| EF35¹⁾ | H22 | Copo VFA/AN/Na itaconate = | 1.5 | 8 | 5.8 |
| | | 49.5/49.5/1.0, | | | |
| | | K 174, HG >95% | | | |
| EF36¹⁾ | H23 | Copo VFA/NaAS/AN = 50/30/20, | 1.5 | 5 | 11.9 |
| | | K 90, HG >95% | | | |
| EF37 | H24 | Copo VFA/DADMAC = 70/30, | 2 | 5 | 9.8 |
| | | K 80, HG >95% | | | |
| EF38 | PA1 | | 2 | 5 | 9.6 |
| EF39 | PA2 | | 2 | 5 | 10.1 |
| EF40 | PA3 | | 2 | 5 | 8.2 |
| EF41 | PA4 | | 2 | 5 | 4.1 |
| EF42 | PA5 | | 2 | 5 | 4.2 |
| EF43 | PA6 | | 2 | 5 | 3.2 |
| EF44 | SP1 | Hofmann degradation product | 1 | 5 | 2.3 |

HG: degree of hydrolysis
¹⁾HCl hydrolysis
²⁾VAc fully hydrolyzed
³⁾1,4-CHD: amount of 1,4-cyclohexanedione admixed in mol % based on the polymer's combined amount of primary amino groups and amidine groups
⁴⁾PG: polymer content without counter-ion

### PERFORMANCE EXAMPLES

### General Method of Production for Test Liners—Examples 1 to 44

### Water-Soluble Polymeric Anionic Compound A

The water-soluble polymeric anionic compound A has the following monomer composition: 70 mol % of acrylamide and 30 mol % of acrylic acid. It further has an M_{w} of 800 000 g/mol and an anionic charge density of −3.8 meq/g.

### Further Compounds Used as Auxiliaries:

retention aid: Percol 540 polyacrylamide emulsion having a solids content of 43%, a cationic charge density of 1.7 mmol/100 g and a K value of 240.

### Pretreatment of Paper Stock:

A 100% wastepaper stock (a mixture of the varieties 1.02, 1.04, 4.01) was beaten with tap water in a pulper at a consistency of 4 wt % until free of fiber bundles and ground in a refiner to a freeness of 40° SR. This stuff was subsequently diluted with tap water to a consistency of 0.8 wt %.

The paper stock gave a Schopper-Riegler value of SR 40 in the drainage test.

The wastepaper-based paper stock thus pretreated was admixed under agitation with the table 4 aqueous compositions of Examples EF1-EF44. The aqueous composition was admixed at 0.5 wt % of polymer having primary amino groups and/or amidine groups (solids) based on fibrous wastepaper material (solids). Thereafter (after 30 seconds' of stirring), the water-soluble polymeric anionic compound A was added. The amount in which the water-soluble polymeric anionic compound was added was at 0.3 wt % based on fibrous wastepaper material (solids). The retention aid (Percol 540) was then added to the paper stock in the form of a 1 wt % aqueous solution meaning that 0.04 wt % of polymer (solids) based on fibrous wastepaper material (solids) was used. The pH of the paper stock was maintained at a constant pH 7 (by means of 5 wt % sulfuric acid).

Test papers were then produced using a dynamic sheet-former from Tech Pap, France. The paper was subsequently dried, with contact dryers, to a paper moisture content of 5 wt %.

Reference (not in Accordance with the Present Invention)

For reference, the general procedure for producing test liners was followed to produce a paper stock suspension, and sheets of paper therefrom, without adding the aqueous composition and without adding the water-soluble polymeric anionic compound A.

### Comparative Example 1 (not in Accordance with the Present Invention)

For comparison, the general procedure for producing test liners was followed to produce a paper stock suspension, and sheets of paper therefrom, by using polymer H4 instead of the inventive composition.

The amount of polymer H4 admixed was chosen such that 0.5 wt % of polymer having primary amino groups (solids) based on fibrous wastepaper material (solids) was used. As described in the general method of production, polymer H4 was added first, 30 seconds before the addition of the water-soluble polymeric anionic compound in an amount of 0.3 wt % based on fibrous wastepaper material (solids).

The papers collated in table 5 below were produced.

### Performance Testing of Test Papers

The paper was conditioned at 50% relative humidity for 24 hours and then subjected to the following strength tests:
bursting pressure as per DIN ISO 2758 (up to 600 kPa) and DIN ISO 2759 (above 600 kPa)
SCT shortspan compression test as per DIN 54518 (quantification of strip crush resistance)
CMT corona medium test as per DIN EN 23035 (quantification of flat crush resistance)

As is apparent from the results in table 5, the separate employment of the water-soluble polymeric anionic compound and of the aqueous compositions comprising polymers having primary amino groups and/or amidine groups and 1,4-cyclohexanedione provides a significant increase in paper strengths.

TABLE 5
Performance test results

| | | Parts | | | | | | | |
|---|---|---|---|---|---|---|---|---|---|
| | | by | Basis | | | | | | |
| | Aqueous | weight | weight | CMT | CMT | SCT | SCT | Burst | Burst |
| Ex. | composition | (solids)¹⁾ | [g/m²] | [N * m²/g] | [%] | [kN * m²/g] | [%] | [kPa * m²/g] | [%] |
| reference | — | — | 120 | 1.61 | 0 | 1.24 | 0 | 2.56 | 0 |
| Comp. 1 | polymer | 0.5 | 121 | 2.17 | 35 | 1.55 | 25 | 3.46 | 35 |
| | H4 | | | | | | | | |
| 1 | EF1 | 0.5 | 121 | 2.31 | 44 | 1.56 | 26 | 3.71 | 45 |
| 2 | EF2 | 0.5 | 120 | 2.49 | 55 | 1.77 | 43 | 3.74 | 46 |
| 3 | EF3 | 0.5 | 121 | 2.46 | 53 | 1.79 | 45 | 3.66 | 43 |
| 4 | EF4 | 0.5 | 122 | 2.41 | 50 | 1.76 | 42 | 3.58 | 40 |
| 5 | EF5 | 0.5 | 121 | 2.41 | 50 | 1.73 | 40 | 3.58 | 40 |
| 6 | EF6 | 0.5 | 120 | 2.54 | 58 | 1.83 | 48 | 3.81 | 49 |
| 7 | EF7 | 0.5 | 121 | 2.51 | 56 | 1.82 | 47 | 3.79 | 48 |
| 8 | EF8 | 0.5 | 120 | 2.49 | 55 | 1.79 | 45 | 3.71 | 45 |
| 9 | EF9 | 0.5 | 120 | 2.25 | 40 | 1.67 | 35 | 3.56 | 39 |
| 10 | EF10 | 0.5 | 121 | 2.49 | 55 | 1.76 | 42 | 3.66 | 43 |
| 11 | EF11 | 0.5 | 121 | 2.44 | 52 | 1.79 | 45 | 3.66 | 43 |
| 12 | EF12 | 0.5 | 120 | 2.39 | 49 | 1.83 | 48 | 3.58 | 40 |
| 13 | EF13 | 0.5 | 120 | 2.38 | 48 | 1.828 | 47 | 3.58 | 40 |
| 14 | EF14 | 0.5 | 120 | 2.25 | 40 | 1.67 | 35 | 3.56 | 39 |
| 16 | EF16 | 0.5 | 120 | 2.22 | 38 | 1.72 | 39 | 3.53 | 38 |
| 17 | EF17 | 0.5 | 120 | 2.25 | 40 | 1.73 | 40 | 3.58 | 40 |
| 18 | EF18 | 0.5 | 120 | 2.33 | 45 | 1.78 | 44 | 3.64 | 42 |
| 24 | EF24 | 0.5 | 121 | 2.33 | 45 | 1.78 | 44 | 3.66 | 43 |
| 25 | EF25 | 0.5 | 120 | 2.31 | 44 | 1.773 | 43 | 3.74 | 46 |
| 26 | EF26 | 0.5 | 121 | 2.41 | 50 | 1.83 | 48 | 3.76 | 47 |
| 27 | EF27 | 0.5 | 120 | 2.35 | 46 | 1.81 | 46 | 3.71 | 45 |
| 28 | EF28 | 0.5 | 120 | 2.38 | 48 | 1.82 | 47 | 3.66 | 43 |
| 31 | EF31 | 0.5 | 120 | 2.22 | 38 | 1.61 | 30 | 3.46 | 35 |
| 32 | EF32 | 0.5 | 121 | 2.23 | 39 | 1.63 | 32 | 3.43 | 34 |
| 33 | EF33 | 0.5 | 120 | 2.20 | 37 | 1.67 | 35 | 3.51 | 37 |
| 34 | EF34 | 0.5 | 120 | 2.41 | 50 | 1.79 | 45 | 3.66 | 43 |
| 35 | EF35 | 0.5 | 120 | 2.43 | 51 | 1.82 | 47 | 3.64 | 42 |
| 39 | EF39 | 0.5 | 120 | 2.33 | 45 | 1.78 | 44 | 3.58 | 40 |
| 41 | EF41 | 0.5 | 120 | 2.38 | 48 | 1.78 | 44 | 3.76 | 47 |
| 42 | EF42 | 0.5 | 121 | 2.33 | 45 | 1.77 | 43 | 3.66 | 43 |
| 44 | EF44 | 0.5 | 120 | 2.23 | 39 | 1.73 | 40 | 3.02 | 37 |

¹⁾amount of polymer with primary amino groups and/or amidine groups (solids) used in the form of the aqueous composition of the present invention.
The % age for CMT, SCT and Burst indicates in each case the % increase versus reference.

The performance test data reveal that in each case the use of the inventive combination of water-soluble polymeric anionic compound A and aqueous composition EF5, EF6 or EF7, each comprising polymer H4 and 1,4-cyclohexanedione (Examples 4, 5 and 6), leads to distinctly enhanced strengths for the papers as compared with paper obtained only by using polymer H4 combined with the water-soluble polymeric anionic compound A (Comp. 1).

### Examples 45, 46 and 47

Example 45 utilized the water-soluble polymeric anionic compound P4.

Example 46 utilized the water-soluble polymeric anionic compound P7.

Example 47 utilized the water-soluble polymeric anionic compound P8.

### General Method of Production

The pretreated wastepaper-based paper stock (see above) was admixed with the aqueous composition of Example EF7 under agitation. The aqueous composition was admixed at 0.5 wt % of polymer having primary amino groups and/or amidine groups (solids) based on fibrous wastepaper material (solids). Thereafter (after 30 seconds' of stirring), the respective water-soluble polymeric anionic compound A was added. The amount in which the water-soluble polymeric anionic compound was added was at 0.3 wt % based on fibrous wastepaper material (solids).

The retention aid (Percol 540) was then added to the paper stock in the form of a 1 wt % aqueous solution meaning that 0.04 wt % of polymer (solids) based on fibrous wastepaper material (solids) was used. The pH of the paper stock was maintained at a constant pH 7 (by means of 5 wt % sulfuric acid).

Test papers were then produced using a dynamic sheet-former from Tech Pap, France. The paper was subsequently dried, with contact dryers, to a paper moisture content of 5 wt %.

Reference (not in Accordance with the Present Invention)

For reference, the general procedure for producing test liners was followed to produce a paper stock suspension, and sheets of paper therefrom, without adding the aqueous composition and without adding the water-soluble polymeric anionic compound.

TABLE 6
Performance test results

| | | | Basis | | | | | | |
|---|---|---|---|---|---|---|---|---|---|
| | Aqueous | | weight | CMT | CMT | SCT | SCT | Burst | Burst |
| Example | composition | P^{P} | [g/m²] | [N * m²/g] | [%] | [kN * m²/g] | [%] | [kPa * m²/g] | [%] |
| reference | — | — | 120 | 1.61 | 0 | 1.24 | 0 | 2.56 | 0 |
| 45 | EF 7 | P4 | 121 | 2.30 | 43 | 1.67 | 35 | 3.46 | 35 |
| 46 | EF 7 | P7 | 121 | 2.39 | 49 | 1.83 | 48 | 3.58 | 40 |
| 47 | EF 7 | P8 | 120 | 2.31 | 44 | 1.77 | 43 | 3.74 | 46 |

P: water-soluble polymeric anionic compound
The % age for CMT, SCT and Burst indicates in each case the % increase versus reference.

1: A process for producing paper or board, which process comprises:
admixing
(I) an aqueous composition of pH ≦6, and
(II) at least one water-soluble polymeric anionic compound
to a paper stock having a pH in the range from 6 to 8 and then dewatering the paper stock by sheet formation and drying,
wherein the aqueous composition comprises
(a) a polymer having a primary amino group and/or amidine group to a combined content for these groups of ≧1.5 meq/g of polymer, and
(b) 0.01 to 50 mol % of 1,4-cyclohexanedione (b) based on the combined amount of primary amino group and amidine group of the polymer.

2: The process according to claim 1, wherein the aqueous composition comprises ≧50 wt % of water based on the aqueous composition.

3: The process according to claim 1, wherein the pH of the aqueous composition is in the range from 2 to 6.

4: The process according to claim 1, wherein the polymer having the primary amino group and/or amidine group is at least one selected from the group consisting of hydrolyzed homopolymers of N-vinylcarboxamide, hydrolyzed copolymers of N-vinylcarboxamide with further neutral monoethylenically unsaturated monomers, hydrolyzed copolymers of N-vinylcarboxamide with anionic monoethylenically unsaturated monomers, hydrolyzed copolymers of N-vinylcarboxamide with cationic monoethylenically unsaturated monomers, hydrolyzed homopolymers of N-vinylcarboxamide which have been converted in a polymer-analogous manner, Hofmann degradation products of homo- or copolymers of (meth)acrylamide, and polymers comprising ethyleneimine units.

5: The process according to claim 1, wherein the polymer having the primary amino group and/or amidine group is at least one selected from the group consisting of hydrolyzed copolymers of N-vinylcarboxamide with further neutral monoethylenically unsaturated monomers, hydrolyzed copolymers of N-vinylcarboxamide with anionic monoethylenically unsaturated monomers, and hydrolyzed copolymers of N-vinylcarboxamide with cationic monoethylenically unsaturated monomers, and
wherein a degree of hydrolysis of said polymer is ≧10 mol %.

6: The process according to claim 1, wherein the polymer having the primary amino group and/or amidine group is a partially or fully hydrolyzed copolymer obtainable by polymerization of
30-99 mol % of at least one monomer of the formula 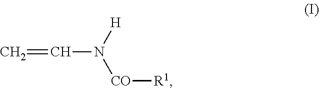
where R¹ is H or C₁-C₆ alkyl,
0-70 mol % of one or more further neutral monoethylenically unsaturated monomers (iia),
0-70 mol % of one or more monomers (iib) selected from monoethylenically unsaturated sulfonic acids, monoethylenically unsaturated phosphonic acids, monounsaturated esters of phosphoric acid, monoethylenically unsaturated carboxylic acids having 3 to 8 carbon atoms in the molecule and/or their alkali metal, alkaline earth metal or ammonium salts,
0-70 mol % of one or more monomers (iic) selected from monoethylenically unsaturated monomers bearing protonatable secondary or tertiary amino groups and quaternized monoethylenically unsaturated monomers,
all based on the overall monomer composition, and
optionally a compound having at least two ethylenically unsaturated double bonds in the molecule,
with the proviso that the sum total for the fractions of monomers (iia), (iib) and (iic) is altogether in the range from 1 to 70 mol %,
and subsequent partial or complete hydrolysis of the polymerized units of monomers (I) in the polymer to form amino groups.

7: The process according to claim 1, wherein the polymer having having the primary amino group and/or amidine group is a partially or fully hydrolyzed copolymer of N-vinylcarboxamide with further neutral, anionic and/or cationic monoethylenically unsaturated monomers, wherein the monomer is at least one selected from the group consisting of acrylonitrile, vinyl acetate, sodium acrylate, diallyldimethylammonium chloride, [3-(dimethylamino)propyl]acrylamide, N-[3-(dimethylamino)propyl]methacrylamide, [3-(trimethylammonio)propyl]acrylamide chloride and N-[3-(trimethylammonio)propyl]methacrylamide chloride.

8: The process according to claim 1, wherein the polymer having the primary amino group and/or amidine group is a partially or fully hydrolyzed copolymer of N-vinylcarboxamide with sodium acrylate, and wherein a degree of hydrolysis of said polymer is ≧30 mol %.

9: The process according claim 1, wherein the polymer having the primary amino group and/or amidine group is a partially or fully hydrolyzed homopolymer of N-vinylcarboxamide, and wherein a degree of hydrolysis of said polymer is ≧30 mol %.

10: The process according to claim 1, wherein the aqueous composition comprises
(a) 5 to 40 wt %, based on the aqueous composition, of polymer the primary amino group and/or amidine group with a combined content for these groups of ≧1.5 meq/g of polymer, and
(b) 0.1 to 30 mol % of 1,4-cyclohexanedione (b) based on the combined amount of primary amino groups and amidine groups of the polymer.

11: The process according to claim 1, wherein the water-soluble polymeric anionic compound has an anionic charge density of >0.1 meq/g (at pH 7).

12: The process according to claim 1, wherein the water-soluble polymeric anionic compound is obtainable by polymerization of
(1) at least one monomer selected from the group consisting of
(1.1) monoethylenically unsaturated sulfonic acids, phosphonic acids, phosphoric esters and other phosphoric acid derivatives bearing at least one hydroxyphosphorus group, and
(1.2) monoethylenically unsaturated mono- and dicarboxylic acids, their salts and dicarboxylic anhydrides,
(2) optionally at least one monoethylenically unsaturated monomer other than said components (1.1) and (1.2), and
(3) optionally at least one compound having at least two ethylenically unsaturated double bonds in the molecule,
with the proviso that the monomer mixture comprises at least one monomer (1) having at least one free acid group and/or acid group in salt form.

13: The process according to claim 1, wherein the water-soluble polymeric anionic compound is a copolymer selected from the group consisting of copolymers of acrylic acid and acrylamide, copolymers of acrylic acid and acrylonitrile, copolymers of acrylic acid and N-vinylformamide, copolymers of methacrylic acid and methacrylamide, copolymers of methacrylic acid and N-vinylformamide, copolymers of acrylic acid and methacrylamide, copolymers of acrylic acid and methacrylonitrile, copolymers of methacrylic acid and methacrylonitrile and copolymers of acrylic acid, acrylamide and acrylonitrile.

14: The process according to claim 1, wherein the polymeric anionic compound is a copolymer of acrylic acid with at least one monomer selected from the group consisting of vinylformamide, vinyl acetate, acrylonitrile and acrylamide.

15: The process according to claim 1, wherein the aqueous composition is added in an amount comprising from 0.01 to 6 wt % of the polymer the primary amino group and/or amidine group, based on fibrous material.

16: The process according to claim 1, wherein wastepaper is used as fibrous material.

17: Paper or board obtained according to a process of claim 1.
